(19) United States
(12) Patent Application Publication
(10) Pub. No.: US 2026/0229006 A1
(43) Pub. Date: Aug. 6, 2026

(54) SYSTEMS AND METHODS OF IDENTIFYING AND ALLOCATING PRODUCTS WITHIN A RETAIL FACILITY

(71) Applicant: Walmart Apollo, LLC, Bentonville, AR (US)

(72) Inventors: Nairwita Mazumder, San Jose, CA (US); Gabriel H. Giraldo-Wingler, Doylestown, PA (US); Steven Duval Ruilova, Solana Beach, CA (US); Darrell Whitelaw, Pacific Palisades, CA (US); Jae Y. Lew, Mill Valley, CA (US); Tushar Dadlani, San Francisco, CA (US); Matthew S. Brown, Kinnelon, NJ (US); Andrew J. Grignon, Roseville, CA (US); Stephen S. Hadinger, Berkeley, CA (US)

(21) Appl. No.: 19/042,405

(22) Filed: Jan. 31, 2025

(51) Int. Cl. G06V 10/70; G06Q 30/0601; G06V 40/16

(52) U.S. Cl. CPC G06V 10/70; G06Q 30/0633; G06V 40/172

(57) ABSTRACT

In some embodiments, apparatuses and methods are provided herein useful to identify and allocate products within a retail facility. A system may include a first set of cameras to capture sets of person images of a person and a second set of cameras to capture sets of product images of products. The system includes a person identification control circuit to process a first set of person images and generate a unique first person identifier, and a product identification control circuit to: determine there is a difference in a number of products, identify a product removed based on the determined difference; and determine that the person is at least a threshold distance from where the first product was identified; and a cart generation control circuit to: generate a virtual first zone cart associated with the first person identifier; and add the first product to the virtual first zone cart.

### TECHNICAL FIELD

This disclosure relates generally to inventory control.

### BACKGROUND

Many retail facilities sell a large number of different products and types of products. Products are typically picked up by a customer and transported by the customer to a point-of-sale (POS) system. There is a need to improve the control of inventory and customer purchasing.

### BRIEF DESCRIPTION OF DRAWINGS

Disclosed herein are embodiments of systems, apparatuses and methods pertaining to controlling segmentation and product correlation, and identifying and allocating products within a retail facility. This description includes drawings, wherein:

FIG. 1 illustrates a block diagram of an example product identification and allocation system in accordance with some embodiments.

FIG. 2A illustrates an overhead view of at least a portion of an example product identification and allocation system in accordance with some embodiments.

FIG. 2B illustrates an overhead view of at least a portion of an example product identification and allocation system in accordance with some embodiments.

FIG. 2C illustrates an overhead view of at least a portion of an example product identification and allocation system in accordance with some embodiments.

FIGS. 3A-3B illustrate block diagram, overhead views of respective portions of example product identification and allocation systems in accordance with some embodiments.

FIG. 3C illustrates a block diagram of an example retail facility with example zones defined throughout at least some portions of the facility, in accordance with some embodiments.

FIG. 4 illustrates a profile view of a portion of an example person identification system of an example product identification and allocation system in accordance with some embodiments.

FIG. 5A illustrates a perspective view of an example product identification and allocation subsystem relative to an example product support system, in accordance with some embodiments.

FIG. 5B illustrates a perspective view of an example product identification and allocation subsystem relative to an example product support system, in accordance with some embodiments.

FIG. 5C illustrates a perspective view of an example product identification and allocation subsystem, in accordance with some embodiments.

FIGS. 6A-6C illustrate perspective views of example identification and allocation subsystems in accordance with some embodiments.

FIGS. 7A-7B illustrate example field of view of one or more cameras capturing images of respective product support systems, in accordance with some embodiments.

FIGS. 8A-8B illustrate example field of view of one or more cameras capturing images of respective product support systems, in accordance with some embodiments.

FIG. 9A illustrates a perspective view of an example identification and allocation subsystem in accordance with some embodiments.

FIG. 9B illustrates a perspective view of an example identification and allocation subsystem in accordance with some embodiments.

FIG. 9C illustrates an exploded perspective view of an example identification and allocation subsystem in accordance with some embodiments.

FIG. 9D illustrates an exploded perspective view of at least a portion of an example identification and allocation subsystem in accordance with some embodiments.

FIG. 9E illustrates an exploded perspective view of at least a portion of an example identification and allocation subsystem in accordance with some embodiments.

FIG. 9F illustrates an exploded perspective view of at least a portion of an example identification and allocation subsystem in accordance with some embodiments.

FIG. 9G illustrates a perspective view of at least a portion of an example identification and allocation subsystem in accordance with some embodiments.

FIG. 9H illustrates a perspective view of at least a portion of an example identification and allocation subsystem in accordance with some embodiments.

FIG. 9I illustrates a perspective view of at least a portion of an example identification and allocation subsystem in accordance with some embodiments.

FIG. 9J illustrates a perspective view of at least a portion of an example identification and allocation subsystem in accordance with some embodiments.

FIG. 10 illustrates a perspective view of an example identification and allocation subsystem in accordance with some embodiments.

FIG. 11A illustrates a perspective view of at least a portion of an example identification and allocation subsystem in accordance with some embodiments.

FIG. 11B illustrates a perspective view of at least a portion of an example identification and allocation subsystem in accordance with some embodiments.

FIG. 11C illustrates a perspective view of at least a portion of an example identification and allocation subsystem in accordance with some embodiments.

FIG. 12 illustrates an architectural flow diagram of an example process of product identification and allocation in accordance with some embodiments.

FIG. 13 illustrates an architectural flow diagram of product identification and allocation in accordance with some embodiments.

FIG. 14 illustrates a block diagram of product identification and allocation in accordance with some embodiments.

FIG. 15 illustrates a block diagram of product identification and allocation in accordance with some embodiments.

FIG. 16 illustrates a block diagram of product identification and allocation in accordance with some embodiments.

FIG. 17 illustrates a block diagram of an example system for use in implementing methods, techniques, devices, apparatuses, systems, servers, sources, and providing product identification and allocation, in accordance with some embodiments.

FIG. 18A illustrates a flow diagram of an example process of product identification and allocation in accordance with some embodiments.

FIG. 18B illustrates a flow diagram of an example process of product identification and allocation in accordance with some embodiments.

FIG. 18C illustrates a flow diagram of an example process of product identification and allocation in accordance with some embodiments.

FIG. 18D illustrates a flow diagram of an example process of product identification and allocation in accordance with some embodiments.

FIG. 18E illustrates a flow diagram of an example process of product identification and allocation in accordance with some embodiments.

FIGS. 19A-19B illustrates a flow diagram of an example process of controlling a retail facility in accordance with a segmentation into zones and control purchase systems to automate product allocation and purchase, in accordance with some embodiments.

FIG. 20 illustrates a flow diagram of a process of dividing up and defining multiple zones distributed through a retail facility, in accordance with some embodiments.

FIG. 21 illustrates a flow diagram of an example process of controlling a confirmation of payment, in accordance with some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments. Also, common but well-understood elements that are useful or necessary in a commercially feasible embodiment are often not depicted in order to facilitate a less obstructed view of these various embodiments. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

The following description is not to be taken in a limiting sense, but is made merely for the purpose of describing the general principles of example embodiments. Reference throughout this specification to “one embodiment,” “an embodiment,” “some embodiments”, “an implementation”, “some implementations”, “some applications”, or similar language means that a particular feature, structure, or characteristic described in connection with the embodiment is included in at least one embodiment of the disclosure. Thus, appearances of the phrases “in one embodiment,” “in an embodiment,” “in some embodiments”, “in some implementations”, and similar language throughout this specification may, but do not necessarily, all refer to the same embodiment.

The ability to identify products retrieved by customers within a retail facility, associate those items with the customer and/or virtual cart and complete a sale of those items has previously been extremely computationally complex, can take unacceptably long, and often results in significant errors. The present embodiments, however, provide enhanced systems and methods that greatly reduce the computational complexity, incorporate a distributed system that distributes processing, reduces processing times, improves the accuracy of the detection of products retrieved by people as they move through the facility, reduces the computational complexity and processing needed to accurately identify products and the association of retrieved products with a particular person that retrieved that product, simplifies the management of virtual carts, increases the accuracy of virtual cart compilation, and other improvements. These improvements further improve operational efficiency, improve inventory management, improve customer satisfaction, reduce lost revenue, increase sales and other benefits. Additionally, some embodiments improve the operation of the system in part by distributing the processing to multiple systems each associated with a zone of the facility, which further improves results, simplifies computational processing, reduces network bandwidth and provides other benefits.

The systems and method for product identification and allocation described herein provide improved utilization of spatial information to facilitate cart generation on a per-user basis within a shop-and-go system of a retail facility. A user is uniquely identified as they enter a segment of a facility, and an image (including the items'universal product codes and coordinates) is captured of the segment and associated with the uniquely identified user. When the user leaves the segment, a new image is taken including all of the items in the segment, and the difference in items between entry and exit of the user is evaluated and used to generate or update a cart for the uniquely identified user. A user is able to leave the facility with no additional physical point-of-sale (POS) transaction proceeding shopping as a result of the continuous updating of the cart associated with the user. The present disclosure decreases reliance on third party devices used to update carts associated with a user.

Generally speaking, pursuant to various embodiments, systems, apparatuses and methods are provided herein useful to product identification and allocation within a retail facility. In some embodiments, a system for product identification and allocation within a retail facility includes a first set of cameras, a second set of cameras, a person identification control circuit, a product identification control circuit, and a cart generation control circuit. The first set of cameras can each be positioned at a different one of first predefined locations corresponding to a first zone, of multiple different zones throughout a retail facility, and the first set of cameras is configured to capture sets of person images of a person at the first zone. The plurality of second cameras can each be positioned at a different one of second predefined locations in the first zone, and the second set of cameras is configured to capture sets of product images of products within the first zone and available for purchase by customers. The person identification control circuit can be configured to process a first set of person images, of the sets of person images, and generate a unique first person identifier of the person captured within the first set of person images based on at least the first set of person images of the person at the first zone. The product identification control circuit can be configured to: determine there is a difference in a number of products within the first zone by comparing a first set of product images before a threshold first period of time has elapsed and a second set of product images after the threshold first period of time has elapsed; identify a first product removed based on the determined difference in the number of products within the first zone; and determine that the person is at least a threshold first distance from a portion of shelves where the first product was identified, at or after the threshold first period of time. The cart generation control circuit can be configured to generate a virtual first zone cart associated with the first person identifier and the first zone, and virtually add the first product to the virtual first zone cart associated with the first person identifier.

Some embodiments provide methods and/or processes of identifying and allocating products in a retail facility. A first set of cameras each positioned at a different one of first predefined locations corresponding to a first zone, of multiple different zones throughout a retail facility, can capture sets of person images of a person at the first zone. A second set of cameras each positioned at a different one of second predefined locations in the first zone, can capture sets of product images of products within the first zone and available for purchase by customers. A first set of person images, of the sets of person images, can be processed and a unique first person identifier of the person captured within the first set of person images can be generated based on at least the first set of person images of the person at the first zone. A difference in a number of products within the first zone can be determined by comparing a first set of product images before a threshold first period of time has elapsed and a second set of product images after the threshold first period of time has elapsed. A first product removed can be identified based on the determined difference in the number of products within the first zone. A person being at least a threshold first distance from a portion of shelves where the first product was identified can be determined, at or after the threshold first period of time. A virtual first zone cart associated with the first person identifier and the first zone can be generated, and the first product can be virtually added to the virtual first zone cart associated with the first person identifier.

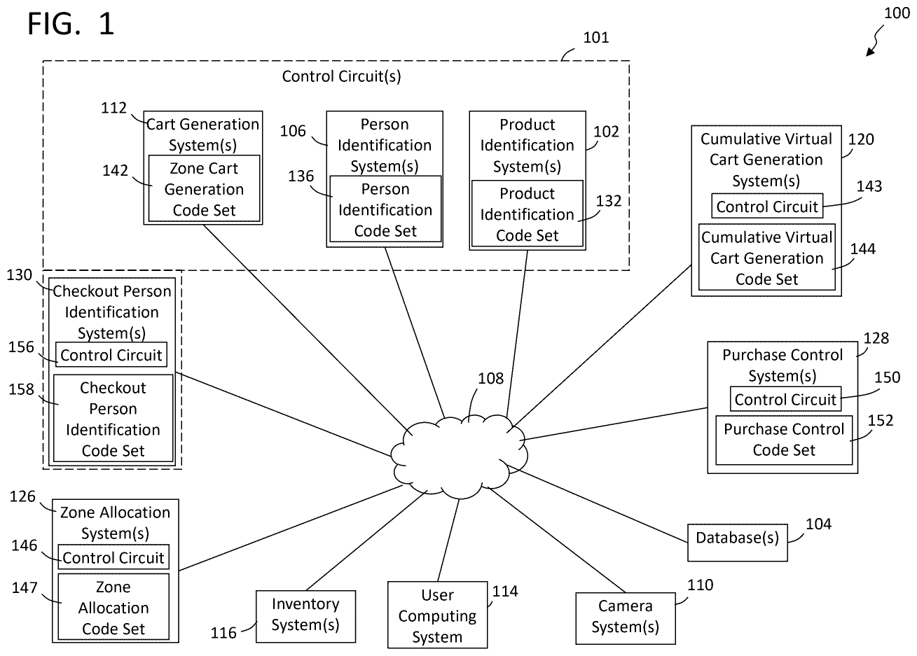

FIG. 1 illustrates a block diagram of an example product identification and allocation system 100. Although the present embodiments will be described with reference to the embodiments shown in the Figures, it should be understood that the present disclosure may be embodied in many forms of alternative embodiments. In addition, any suitable size, shape or type of materials or elements can be used.

Referring to FIG. 1, the product identification and allocation system 100 in some embodiments includes one or more product identification systems 102, one or more person identification systems 106, one or more camera systems 110, one or more cart generation systems 112, and one or more inventory systems 116 communicatively coupled over one or more computer and/or communication networks 108. The product identification and allocation system 100 further includes one or more databases 104. In some embodiments, the product identification and allocation system 100 further comprises one or more cumulative virtual cart generation systems 120 that can comprise one or more cumulative virtual cart control circuits 143 that communicatively coupled with one or more computer readable tangible medium storing a cumulative virtual cart generation code set 144 that is executable by the one or more cumulative virtual cart control circuits 143. In some embodiments, the product identification and allocation system 100 can include one or more zone allocation systems 126 that can comprise one or more zone allocation control circuits 146 that communicatively coupled with one or more computer readable tangible medium storing a zone allocation code set 147 that is executable by the one or more zone allocation control circuits 146. The product identification and allocation system 100 can, in some embodiments, include and/or communicatively couple with one or more purchase control systems 128 that can comprise one or more purchase control circuits 150 that communicatively coupled with one or more computer readable tangible medium storing a purchase code set 152 that is executable by the one or more purchase control circuits 146. Further in some embodiments, the product identification and allocation system 100 can comprise and/or communicatively couple with one or more checkout person identification systems 130 that can comprise one or more checkout person identification control circuits 156 that communicatively coupled with one or more computer readable tangible medium storing a checkout person identification code set 158 that is executable by the one or more checkout person identification control circuits 156.

The product identification and allocation system 100 is further in communication with one or more user computing systems 114 or user interface units, such as but not limited to user smartphones, tablets, laptops, computers, servers, and/or other such individual and/or networked computing systems that enable a user to communicate with the product identification and allocation system 100. One or more of the user computing systems 114 may be part of the product identification and allocation system 100, and/or one or more of the user computing systems 114 may be separate and distinct from the product identification and allocation system 100. The product identification and allocation system 100 can further include and/or be in communication with, via the one or more communication networks 108, the one or more databases 104, such as one or more inventory databases, one or more shipping databased, one or more customer databases, other such databases, and typically a combination of two or more of such databases. One or more of the databases may be maintained locally, remotely or a combination of locally and remotely through one or more computer memory storage systems that are accessible through one or more distributed computer and/or communication networks 108. In some embodiments, one or more control circuits 101, executing one or more code sets stored in one or more computer memory storage systems, implement one or more of the product identification systems 102, person identification systems 106, cart generation systems 112 and/or cumulative virtual cart generation systems.

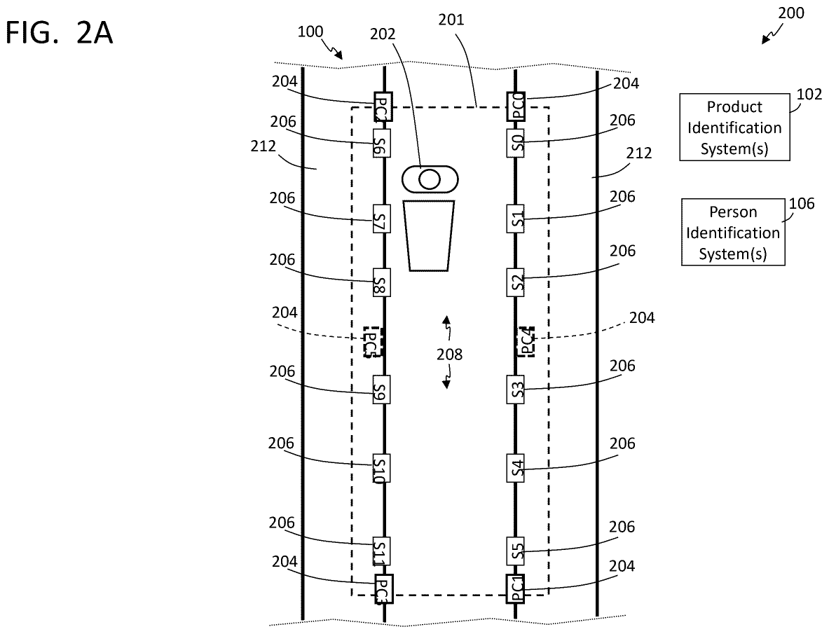

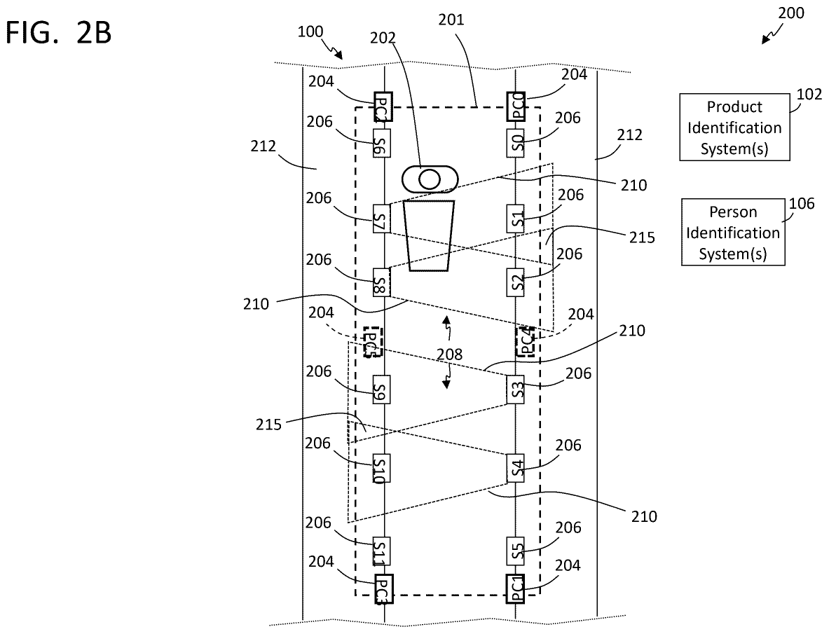

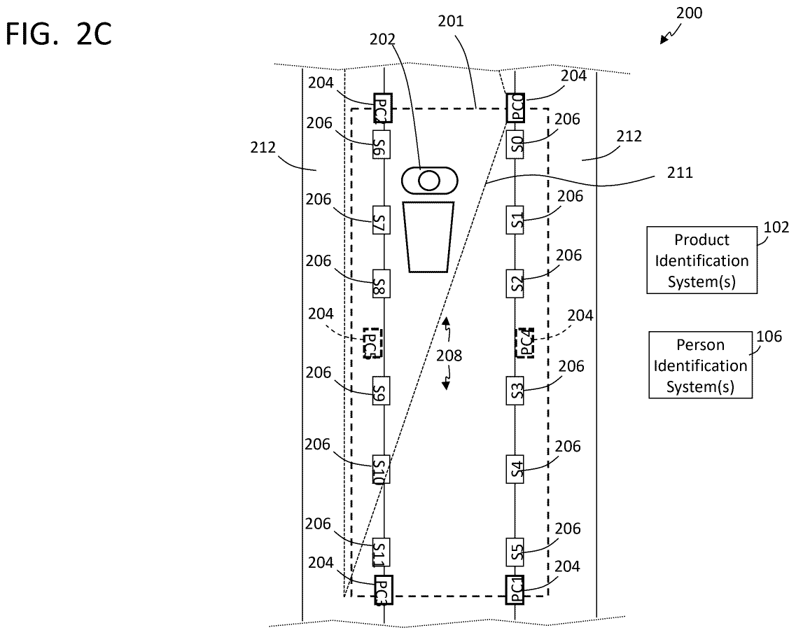

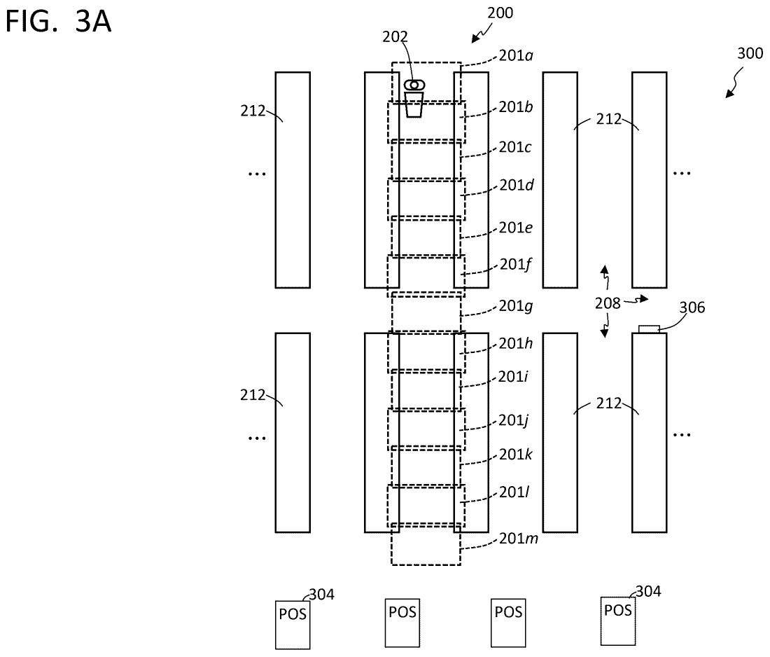

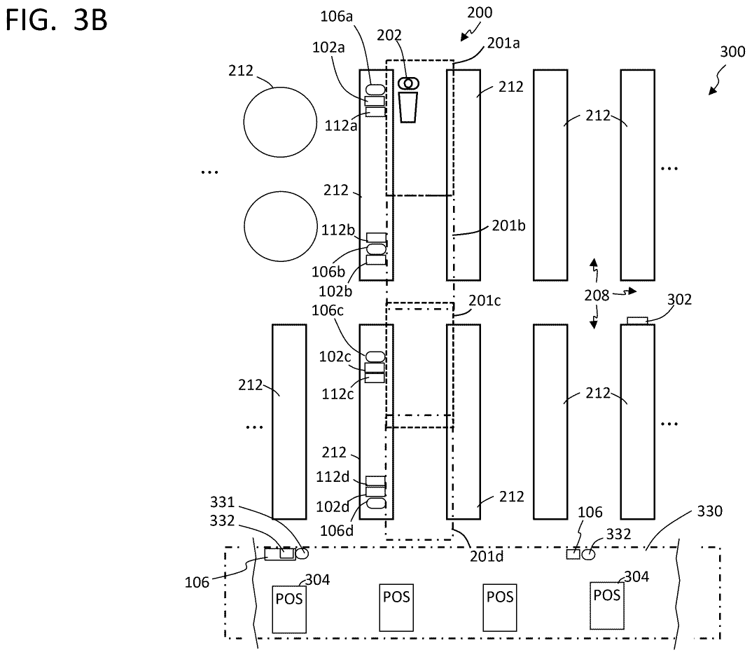

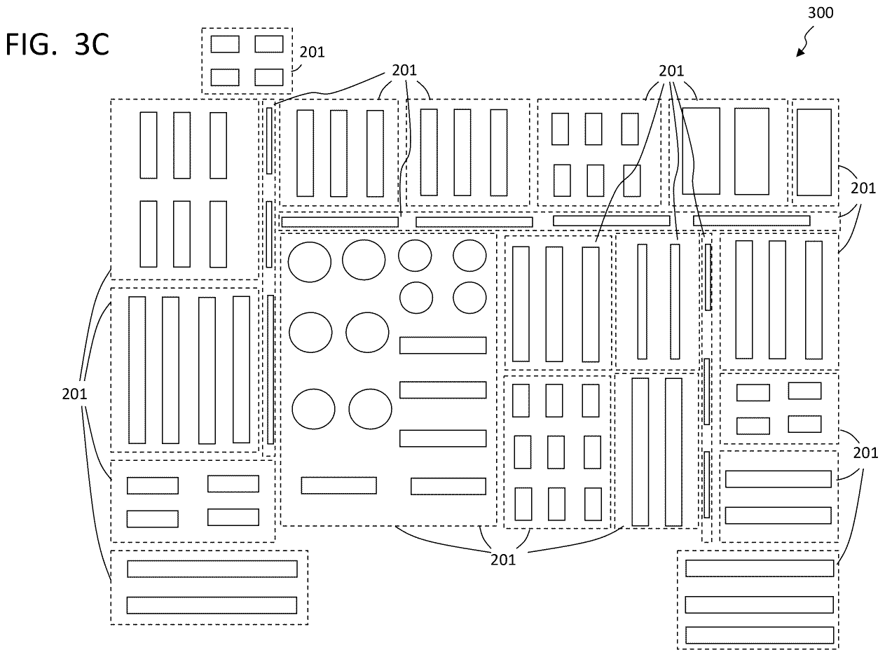

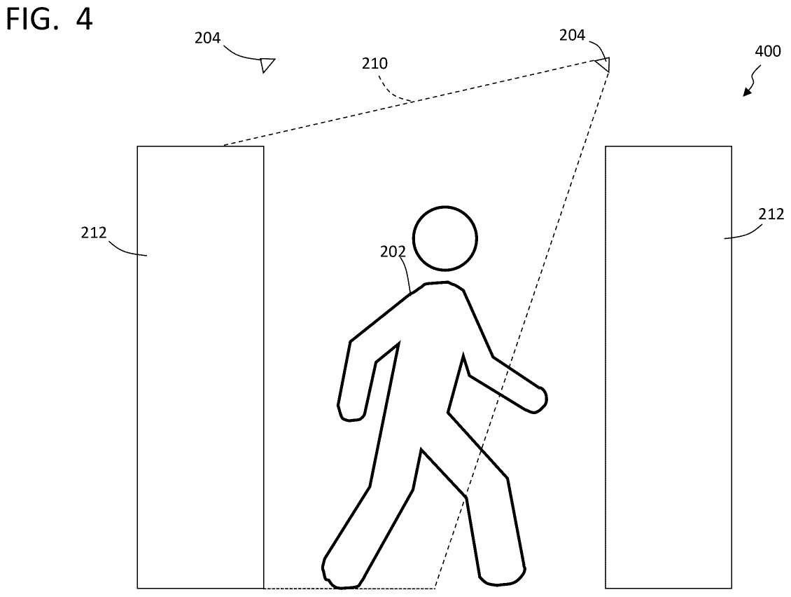

FIG. 2A illustrates a block diagram, overhead view of at least a portion of an example product identification and allocation system 100, in accordance with some embodiments, associated with a zone 201 within a retail facility 300. FIG. 2B illustrates a block diagram, overhead view of at least a portion of an example product identification and allocation system 100 associated with a zone 201 within a facility 300, in accordance with some embodiments. FIGS. 3A and 3B illustrate block diagram, overhead views of at least a respective portion of a respective example product identification and allocation system 100 within a respective example facility 300, in accordance with some embodiments. FIG. 3C illustrates a block diagram of an example retail facility 300 with example zones 201 defined throughout at least some portions of the facility, in accordance with some embodiments. FIG. 4 illustrates a block diagram of a portion of an example person identification system 106 of an example product identification and allocation system 100, in accordance with some embodiments. In some embodiments, two or more of the zones 201, and typically each zone 201 includes one or more control circuits 101 positioned locally at the respective zone, and can be communicatively coupled with one or more other components of the product identification and allocation system 100 and/or external systems through the one or more networks 108, and configured to locally execute one or more of product identification, person identification, zone virtual cart generation, and/or other such functionality as described herein with respect to the respective zones 201.

Referring to FIGS. 1, 2A-2C, 3A-3C, and 4, in some embodiments, the product identification and allocation system 100 can operate as a shop-and-go system within a retail facility 300 that allows a person 202 (also referred to herein as a customer, associate and/or a user) to shop for and purchase products for sale within the retail facility 300 without the person having to perform a physical purchase transaction at a point-of-sale (POS) system 304 within the retail facility 300. Generally, the retail facility 300 includes one or more product support systems 212. The retail facility 300 can include multiple aisles 208 defined by product support systems 212 that can comprise one or more shelves, one or more racks, one or more trays, one or more bins, one or more tables, other such support systems, or a combination of two or more support systems that can support different products intended to be purchased by customers. One or more of the product support systems can be arranged to establish and/or define aisles 208. The one or more product support systems 212 can be spaced such that an aisle 208 is formed between adjacent sides of separated product support systems 212 and/or between a side of a product support system 212 and an alternate structure (e.g., a wall) within the retail facility 300. A single product support system 212 may define a boundary of any suitable number of aisles 208. The product support systems 212 may have any suitable number, dimensions, spacing, and/or configuration within the retail facility 300. A product support system 212 may further include any suitable number of shelves and/or spacing between shelves, and a product support system 212 may further include shelves on any suitable number of sides of the product support system 212. For example, a product support system 212 may include sets of shelves on two sides of the product support system 212 such that products, placed on and supported by the shelves, are accessible from aisles 208 on either side of the product support system 212.

The product identification and allocation system 100 can further include and/or define multiple zones 201, regions or other such portions of the retail facility. The zones 201 can define corresponding volumes or areas of the retail facility 300 in which products are positions. The zones 201 may define any suitable portion of the retail facility 300 and can have substantially any relevant suitable size, shape, and/or number. In some embodiments, each zone 201 corresponds with different categories or sub-categories of products or sections of the store (e.g., home, beauty, garden, and so forth). In some embodiments, as shown in FIGS. 3A-3C, zones 201a-201m can for example correspond with portions of product support systems 212 accessible from an aisle 208 defined by the opposing product support systems 212. The example product identification and allocation system 100 described herein can comprise a plurality of product identification and allocation subsystems 200 or modules spaced throughout the retail facility 300 in accordance with some embodiments. In some embodiments, each product identification and allocation subsystem 200 corresponds to a single zone, and/or one or more of the zones 201 can correspond with at least one product identification and allocation subsystem 200. Generally, the product identification and allocation subsystems 200 are positioned to identify products retrieved from the product support systems and virtually allocate the retrieved products to a specific customer determined to have retrieved the respective product. Each zone 201a-201d, in some embodiments, is associated with and/or includes a respective product identification system 102a-102d and a person identification system 106a-106d, and in some embodiments cart generation system 112a-112d. In some forms, the product identification and allocation subsystems 200 are configured to directly attach to a product support system 212, be suspended above one or more zones (e.g., above one or more product support systems 212 and/or one or more aisles 208, otherwise positioned relative to a corresponding zone, or cooperated through some combination of such positioning.

The product identification and allocation system 100 includes the one or more imaging and/or camera systems 110 that may comprise a first set of cameras 204 configured to capture images of people 202 within the retail facility 300, and a second set of cameras 206 configured to capture images of products within the retail facility 300. The first set of cameras 204 can be generally communicatively coupled to one or more person identification systems 106 via the communication networks 108, and/or communicatively coupled with a computer memory accessible by both the first set of cameras and at least one person identification system 106. The second set of cameras 206 of the one or more camera systems 110 can be communicatively coupled to the one or more product identification systems 102 via the communication network 108, and/or communicatively coupled with a computer memory accessible by both the second set of cameras and at least one product identification system 102. It is generally contemplated that the one or more camera systems 110 may include alternate and/or additional cameras for any alternate and/or additional purposes within the product identification and allocation system 100.

Still referring to FIGS. 1 and 2A, in some embodiments a product identification and allocation subsystem 200 corresponding to a first zone 201, of the multiple different zones, can comprise a first set of cameras 204 each positioned at a different one of first predefined locations corresponding to a first zone 201. The first set of cameras 204 can capture sets of person images that can include one or more people 202 at, within and/or proximate to the first zone 201. There may be any suitable number of cameras 204 configured to capture images of people 202 relative to a zones 201. In some forms, the cameras of the first set of cameras 204 may be stationary and/or fixed, and can capture images with any relevant suitable speed, frequency, and/or field of view 211. In some embodiments, a product identification and allocation subsystem 200 can comprise a second set of cameras 206 each positioned at a different one of second predefined locations in the first zone 201. The second set of cameras 206 can positioned relative to the first zone to capture sets of product images of that include one or more products that are within the first zone 201 and available for purchase by customers. There may be any relevant number of cameras of the second set of cameras 206 that are configured to capture images of products throughout the retail facility 300. In some forms, the cameras of the second set of cameras 206 may be stationary and/or fixed, and can capture images with substantially any relevant suitable speed, frequency, and/or field of view 210.

In some embodiments, each zone 201 includes a first set of cameras 204 and a second set of cameras 206, and the cameras of the first set of cameras 204, and/or the cameras of the second set of cameras 206 are spaced within the zones 201. The cameras of the first set of cameras 204 can be spaced and/or angled to have fields of view 211 and/or establish a cumulative field of view that to enable images of some of a person or the entire person 202 within the respective zone and/or aisle 208 of the zone. In some embodiments, the cameras of the second set of cameras 206 can be spaced and/or angled to have fields of view 210 and/or two or more cumulative fields of view that can capture images of each product intended to be positioned with the respective zone 201. Typically, one or more or all of the fields of view 210 of the second set of cameras 206 are different than one or more or all of the fields of view 211 of the first set of cameras 204. In some embodiments, the first set of cameras 204 and the second set of cameras 206 are positioned on both a first side and a second side of an aisle 208 within a respective zone 201. A first subset of cameras, of the second set of cameras 206, may be positioned on the first side of the aisle 208, within the first zone 201, and are each oriented with a respective field of view 210 directed to the second side of the aisle 208 opposite the first side of the aisle 208. A second subset of cameras, of the second set of cameras 206, may be positioned on the second side of the aisle 208 and are each oriented with a respective field of view 210 directed to the first side of the aisle 208.

FIGS. 2A-2C show a product identification and allocation subsystems 200 including first and second sets of cameras 204, 206 spaced on both sides of an aisle 208 defined by two product support systems 212. Each of the first set of cameras 204 has a respective field of view 211 oriented toward the respective zone 201. In some embodiments, the cameras of the first set of cameras 204 can be positioned and spaced at or near ends of a zone 201, and with some zone configurations one or more cameras of the first set of cameras 204 and can be positioned at one or more locations within the zone (e.g., cameras labeled P0, P1, P2, P3, P4, and P5 of the second set of cameras 206). Similarly, in some embodiments, the cameras of the second set of cameras 206 can be spaced at different locations at and/or within the respective zone 201 along each portion of the product support systems 212 shown with a greater number of cameras 206 than cameras 204 (e.g., cameras labeled S0, S1, S2, S3, S4, S5, S6, S7, S8, S9, S10, and S11 of the first set of cameras 204). The second set of cameras 206 can be positioned, in some embodiments, so that fields of view 211 of neighboring cameras partially overlap and/or establish respective overlap fields 215. FIG. 2B shows example overlapping fields of view 210 of cameras of the second set of cameras 206 (e.g., overlapping representative fields of view of cameras S3 and S4, and overlapping representative fields of view of cameras S7 and S8). FIG. 2C shows an example field of view 211 of a camera of the first set of camera 204 (e.g., a field of corresponding to camera P0), with a person 202 within the field of view 211. It is generally understood that the number of cameras 204, 206 shown is for example only, and that any alternate number and/or spacing between cameras 204, 206 may be used. While the cameras 204, 206 are shown as separate, in some embodiments the cameras 204, 206 may be in the form of a single camera configured to capture images of both products and people 202.

The product identification systems 102, the person identification systems 106 and the cart generation systems 112 can be communicatively coupled with one or more communication networks 108 (e.g., LAN, WAN, cellular network, the Internet, Bluetooth, Wi-Fi, other such networks, or a combination of two or more of such networks). In some embodiments, a product identification and allocation system 100 can comprise one or more control circuits 101 communicatively couple with one or more computer memory storage systems storing one or more code sets executable by the one or more control circuits 101 to implement some or all of a product identification system 102, person identification system 106, a cart generation system 112 and/or a cumulative virtual cart generation system 120. In some embodiments, for example, the person identification systems 106 can each comprise a person identification code set 136 executable by the control circuit 101 (or one or more person identification control circuits), each of the product identification systems 106 can comprise a product identification code set 132 executable by the control circuit 101 (or one or more product identification control circuits), and each of the cart generation systems 112 can comprise a cart generation code set 142 executable by the control circuit 101 (or one or more cart generation control circuits). Further, in some embodiments, each a product identification and allocation subsystem 200 corresponds to a zone and comprises a control circuit 101 positioned local to the zone and configured to execute the person identification code set 136, the product identification code set 132 locally at or within a zone 201, the cart generation code set 142, or a combination of two or more of such code sets. One or more of the zones may alternatively comprise a person identification control circuit and a product identification control circuit positioned locally at or within a zone 201, with the person identification control circuit communicatively coupled via a local communication network with the product identification control circuit. A cart generation system 112 may be local to each zone or may be implemented remote from the zone and be in communication with the control circuit 101, the person identification system 106 and/or the product identification system 102 through one or more of the local and/or distributed networks 108. A

The one or more person identification systems 106 are configured to process person images captured by one or more of the cameras of the first set of cameras 204, and distinguish different people 202 within the retail facility 300. In some embodiments, a person identification system 106 can be associated with one or more zones 201, and in some implementations is local to and exclusively associated with a single zone. The control circuit 101 and/or person identification system can be communicatively coupled with the first set of cameras 204 via the communication network 108 and/or can access a database or other computer storage system in which the person images are transferred from the first set of cameras 206. In example embodiments, a person identification system 106 can access and process a first set of one or more person images, of the sets of person images corresponding with the zone and captured by one or more of the first set of cameras 204 while the person is at the first zone (e.g., within a threshold distance of and/or within the zone), and generate from the first set of images one or more unique first person identifiers of a person 202 captured within the one or more first set of person images based on at least the first set of person images of the person 202 at and/or within a first zone 201. In some implementations, the first person identifier of the person 202 may be generated by generating one or more vectors based on characteristics of the person within the first set of person images, of the person 202 captured within the first set of person images through one or more known techniques (e.g., feature vector(s), coordinate vector(s), motion vector(s), eigenvector(s), etc.).

In some embodiments, the person identification system 106 can be executed to use the one or more unique identifiers generated at different times and/or different locations to determine whether a person captured in two different sets of one or more person images are estimated to be the same person. For example, the person identification system 106 can further process a second set of person images capturing a second person 202 at the same or a different zone 201 and generate one or more unique second person identifiers of the second person 202 captured within the second set of person images. The first and second sets of one or more person identifiers can be evaluated to determine whether a threshold correlation exists between the sets of one or more person identifiers and/or there is a threshold variation between the sets of identifiers. The person identification system 106, in some embodiments for example, can associate the second person identifier with the first person identifier when the second person identifier is within an identifier threshold difference of the first person identifier indicating the person 202 and the second person 202 are estimated to be the same person 202. The person identifiers can be one or more known person identifiers generated through one or more known techniques, such as the generation of one or more vectors corresponding to characteristics of the person in the image (e.g., based on ratio relationships between dimensions of body parts, color patterns, text patterns, symbols, other such characteristics, or a combination of two or more of such characteristics). Substantially any number of sets of person images within one or more zones 201 may be taken over time, and repeatedly detect the correlation between person identifiers from any number of sets of images and respective person identifiers in any number of zones 201.

In some embodiments, the control circuit 101 and/or a person identification system 106 and/or one or more sensor systems can implement at least some control over one or more of the first set of cameras 204 and cause the cameras 204 to capture images in response to a person 202 entering, exiting, and/or moving within a zone 201. For example, the person identification system 106 may activate at least a first camera, of the first set of cameras 204, to capture a first person image of the first set of person images in response to detecting the person 202 entering a first zone 201, and generate a first person identifier in response to the person 202 entering the first zone. Further, the person identification system can activate at least a second camera, of the first set of cameras 204, to capture a second person image of the second set of person images in response to detecting the second person 202 exiting the first zone 201, and generate the unique second person identifier in response to the second person 202 moving a threshold distance, make a threshold movement, exiting the first zone 201, in response to a threshold time duration, and/or other such triggers. While the present embodiment describes the capturing of images by first set of cameras 204 to be in response to movement of a person 202 within a zone 201, it is generally contemplated that one or more or all of the first set of cameras 204 may alternately and/or additionally captured images at pre-determined intervals and/or in response to other triggers (e.g., triggered by the product identification system 104, such as in response to detecting a change in a quantity of products on a shelf, a time laps since a last set of one or more person images, external sensors activating one or more of the first set of cameras 204 and/or other such activations).

The one or more product identification systems 102 can identify products within a facility such as the retail facility 300. The product identification system 102 can be executed to identify a product that has been removed. The product identification system 102 can, in some embodiments, determine that there is a difference in a number of one or more products within a zone 201 based on a comparison of a first set of product images captured before a threshold first period of time has elapsed and a second set of product images after the threshold first period of time has elapsed. The first set of product images and the second set of product images can be taken by the same camera of the second set of cameras 206 or two or more different cameras of the second set of cameras. For example, the first and second sets of product images may be taken with the same fields of view 210, such that the same portion of the product support system 212 is being compared before and after the threshold period of time. It is generally contemplated that any additional number of sets of product images may be taken by any number of the cameras of the second set of cameras 206, and subsequently evaluated to determine whether a difference in products is detected. In some examples, the sets of product images are taken at pre-determined intervals of time, in response to movement detected within a field of view 210 of a camera 206, movement detected by one or more sensors, detected change in weight at a product support system, a detection of an RFID tag, triggered by a person identification system 106, other such triggers or a combination of two or more of such triggers. The product identification system may further identify a first product determined to have been removed from a product support system based on the determined difference in the number of products within the first zone.

In some embodiments, the product identification system 102 and/or a separate evaluation system can determine that a person 202 is at least a threshold first distance from a portion of a product support system where the first product was identified as having been removed, at or after the threshold first period of time. This correlation of a person being the threshold distance, relative to the threshold time and locations between the person and first product enables the product identification system 102, in some implementations, to estimate that the person removed the first product. In some forms, the threshold period of time can correspond to an approximate period of time in which a person 202 may take to decide to purchase a product. In other words, while shopping, customers may pick up and/or look at a product prior to deciding to purchase the product. The threshold period of time may be any suitable pre-determined period of time, and in some respects is a period of time approximately the same as an average period of a time taken by a customer to review the product before taking the product for purchase or placing the product back on a shelf. One or more other threshold periods of time may additionally or alternatively be applied, such as but not limited to a period of time to remove a product and place the product into a shopping cart or basket, an average period of time for people to move the threshold distance, other such thresholds or a combination of two or more of such threshold periods of time.

In some embodiments, the product identification system 106 can be executed to identify that a product has been placed at a different location within a zone 201, and not associate the product with person identifier associated with a person 202 proximate to the product and/or remove an association with the between the product and person when the product is discarded. For example, a customer may pick up a product and move along an aisle 208 with the product, then determine that they do not want to purchase the product, and place the product at a different location. The discarding of the product can indicate it has not been intended for purchase.

One or more products may additionally be associated with the person identifier and/or person as the person moves along a zone. For example, the product identification system 102 may further determine that there is a second difference in a second number of a second set of products within the first zone 201 based on a comparison between a third image captured at a second time and a fourth image captured a threshold second period of time after a second person 202 has moved a threshold second distance from the second set of products. The product identification system can identify a second product, of the second set of products, removed based on the determined second difference in the second number of the second set of products within the first zone 201. For example, the product identification system determines that a second product has been removed at a different point in time than the first product removed, and associates each of the products removed with the person identifier. In some embodiments, person identifiers may be repeatedly generated and confirmed that the person in the sets of images by the first set of cameras 204 are estimated to be the same person. If it is identified (e.g., by the person identification system 106) that a second person identifier is within an identifier threshold difference of a first person identifier, the first and second products removed may be associated with the first person identifier with the assumption that the first person identifier and the second person identifier correspond to the same person 202. If it is not identified that the second person identifier and the first person identifier are within a threshold difference of one another then each of the products removed will be associated with the respective different person identifiers with the assumption that the first person identifier corresponds to a different person than the person from which the second person identifier is generated. It is generally contemplated that any number of products removed within any number of zones 201 may be associated with a same person 202 and/or zone virtual carts combined when respective person identifiers are within threshold differences of one another.

In some embodiments, a person 202 in a zone 201 that is determined to be within a threshold distance from the portion of shelves where a removed product was identified can be associated with a person identifier generated based on that person 202. In some embodiments, the product identification system and/or the person identification system can notify the cart generation system 112 that can, through the execution of a zone cart generation code set 142, associate the removed product with the person identifier corresponding to the person adjacent to the removed product. The threshold distance from the shelves may be any pre-determined threshold, which in some embodiments corresponds to a determined threshold probability the person 202 retrieved the product.

As shown in FIG. 2B, in some embodiments, the cameras (e.g., S0-S1) of the second set of cameras 206 of the product identification system 102 can be spaced such that a first field of view 210 of a first camera (e.g., S7) of the second set of cameras 206 overlaps with a second field of view 210 of an adjacent second camera (e.g., S8) of the second set of cameras 206. In some embodiments, the product identification code set can further take into consideration this overlap of the neighboring fields of view and apply image processing of sets of images captured by two neighboring cameras to determine that both sets of images capture the removal of the same product and prevent associating the same product twice with the person identifier to avoid accounting for the same product multiple times.

The execution of the cart generation code set 142 can generate and/or update a zone virtual cart that is associated, by the cart generation code set, with a particular person identifier of a person detected within a set of images corresponding to a particular zone. As such, in some embodiments, the cart generation code set when executed by one or more processors of the one or more control circuits 101 can be configured to generate a virtual zone cart that exclusively corresponds to a particular zone. The cart generation system 112 can virtually add one or more products that have been detected as removed from one or more shelves and are associated with a person identifier to a zone virtual cart that is associated with the person identifier. In some embodiments, the cart generation system can add additional products to the zone virtual cart as the same person moves through a zone retrieving one or more additional products from the product support system. For example, the cart generation system executed by one or more control circuits can virtually add a second product to the respective virtual zone cart associated with the person identifier and the zone 201 in response to an identification that the second product is removed from the first zone 201 and the identification and/or confirmation that a second person identifier associated with the person 202 proximal the second product is within the identifier threshold difference of the first person identifier. In aspects where there is overlap in the fields of view 210 of cameras 206, the product identification 102 and/or the cart generation system 112 can identify the detection, within two or more different sets of image, captured by overlapping cameras, of the removal of the same product and can prevent that product from being added twice to the virtual zone cart based on the overlap of fields of view of two or more cameras of the second set of cameras 206.

In some embodiments, the product identification and allocation system 100 includes cumulative cart system 120 that can be implemented through the execution, by one or more of the control circuits 101 and/or one or more cumulative virtual cart control circuits 143, of one or more cumulative virtual cart generation code sets 144 to generate a cumulative virtual cart that is exclusively associated with the first person identifier by at least in part combining a virtual first zone cart, associated with a first person identifier, with one or more additional virtual zone carts each exclusively associated with a respective one of additional person identifiers that are each within a threshold difference of the first person identifier. Generally, each of the one or more additional virtual zone carts is associated with a different respective zone 201 of the multiple different zones 201 within the retail facility 300, and each are associated with a corresponding person identifier generated based on images captured while a person was at the corresponding zone. The execution of the cumulative virtual cart generation code set 144 can evaluate different generated person identifiers to determine whether one or more person identifiers are within the threshold difference. In some forms each of the virtual zone carts may be generated in response to the person 202 being identified within a respective zone 201. In some embodiments, the cumulative virtual cart is updated by the cumulative virtual cart generation system 120 over time as a person is detected moving through the facility (e.g., upon exiting a zone, upon passing predefined locations and/or areas, etc.). Additionally or alternatively, the generation and/or updating of the cumulative virtual cart may be initiated and/or updated in response to a detection that the person is completing a shopping experience at the facility (e.g., exiting the retail facility, approaching one of one or more predefined zones within and/or exterior to the facility that are designated as checkout zones 330 (e.g., an area of the facility at or near one or more point-of-sale (POS) systems 304, an exit of the retail facility, a portion of the facility not associated with shopping (e.g., restaurant, optical services, etc.), and/or other such areas.

In some embodiments, a cumulative virtual cart generation control circuit 143 can be communicatively coupled to access different virtual zone carts generated through the execution of the respective zone cart generation code set 142, and configured to generate a cumulative virtual cart combining a first virtual zone cart, which is associated with a first person identifier, with one or more additional virtual zone carts each exclusively associated with a respective one of additional person identifiers, which are generated by a different one of the multiple zone cart generation control circuits, that are each within a threshold correlation, consistency and/or difference of the first person identifier. The cumulative virtual cart is further exclusively associated with the first person identifier providing an aggregation of multiple different zone virtual carts into a single cumulative virtual zone cart.

The cumulative virtual cart generation system 120, through the execution of the cumulative virtual cart generation code set 144, in generating the cumulative virtual cart can be configured to evaluate numerous different person identifiers and identify the one or more additional person identifiers, of the additional person identifiers, that are within an identifier threshold difference of the first person identifier indicating an estimation that the first person identifier and the one or more additional person identifiers were generated based on the first person at different locations within the retail facility. Based on this identified threshold correlation, the one or more additional person identifiers can be associated with and/or designated as equivalent to the first person identifier when the one or more additional person identifiers are within the identifier threshold difference of the first person identifier, and a virtual first zone cart and one or more additional virtual zone carts, each exclusively associated with the one or more additional person identifiers, can be combined into the cumulative virtual cart based on the associating of the first person identifier with the one or more additional person identifiers.

Referring back to FIGS. 3A-3C, in some embodiments the retail facility 300 may include multiple zones 201, multiple aisles 208 defined by multiple product support systems 212, multiple POS locations, and a product drop off 306. One of the aisles 208 is shown to have a person 202 within the aisle 208, and further depicts a plurality of fields of view 210 of respective cameras 204, 206 associated with the aisle 208. The fields of view 210 shown in the image may be of the first set of cameras 204 and/or the second set of cameras 206, and are shown to be overlapping one another. While FIG. 3A shows four vertical aisles 208 and one horizontal aisle 208 defined by ten product support systems 212, it is generally understood that any alternate number, size, and/or configuration of components may be used.

Generally, the zones 201 are virtually distinct areas footprint or volumes of the retail facility 300. In some embodiments, the zones 201 each correspond with, for example, a quantity of different products, a total product count of a volume, density of products, traffic pattern(s) of respective zones and/or neighboring zones, an aisle 208 within the retail facility 300, a department (e.g., home goods, beauty, electronics, etc.), a physical area (e.g., an area bounded by specific dimensions that does not correspond exactly to an aisle or department), other such factors, or a combination of two or more of such factors. In some embodiments, the zones 201 may be identical in size, in other embodiments, the zones 201 may have varying dimensions and/or product counts. The zones 201 each correspond with one or more specified locations within the retail facility 300, and often are continuous regions (e.g., neighboring aisles, adjacent product support systems, etc.) within the facility. While FIGS. 3A-3C show the zones 201 as generally rectangular, the zones 201 may be of any relevant shape and positioned at any relevant portions of the facility.

In some embodiments, the retail facility 300 may include one or more POS systems 304. In some forms, the locations proximate the POS systems 304 may include any combination of checkout areas operated by employees, self-checkout areas, and/or shop-and-go specific checkout areas. A shop-and-go specific POS location may include cameras, such as the cameras 204, configured to identify a person 202, and a mechanism of associating the person 202 with a payment method. For example, a shop-and-go specific POS location may include a card reader which a user can use a credit card with such that the credit card is associated with the user and/or person identifying system (e.g., communication with a user's personal mobile device to acquire an identifier from the mobile device, a user interface enabling a user to enter a user ID and/or passcode, etc.). The POS systems 304 may be communicatively coupled with the first set of cameras 204 such that a person 202 is associated with a person identifier, and the person identifier can be associated with a payment method. In some embodiments, the person identification systems 106 generate a person identifier from an image of a person 202 proximate a POS system 304 and/or location. In some embodiments, the cart generation systems 112 associate the payment method with the person identifier generated associated with the person 202, and further associate a virtual cart with the person identifier and payment method. A user account and/or customer profile may be identified that corresponds to an identified person, and one or more payment methods identified from the profile.

In some embodiments, the product identification and allocation system 100 further includes product drop off areas 306 spaced at various locations throughout the retail facility 300. The product drop off areas 306 may be monitored to indicate to the product identification and allocation system 100 that a product initially intended for purchase by a customer, is no longer intended for purchase. For example, product drop off areas 306 may be monitored similarly to a zone 201 and/or an aisle 208 such that a first set of cameras can capture images used to identify that a person 202 is proximate a product drop off area 306, and a second set of cameras to capture images used to detect that the product has been placed in the area, and the person 202 and product are consequently associated together by any suitable drop off control system and/or control circuit, which may include a person identification system 106 and/or a product identification system 102). A product placed in a product drop off area 306 may be removed from a virtual cart associated with a person identifier that is within a threshold variation of a person identifier generated of a person that placed the product in the product drop off area 306. A product drop off area 306 may be located at the end of a product support system 212, one or more separate areas of a facility, one or more specific bins, other such locations, or a combination of two or more of such locations.

The example product identification and allocation system 100 may include and/or communicatively couple with one or more inventory systems 116 that can be configured to, for example, monitor inventory of products within the retail facility 300 (e.g., product counts, overstock information, understock information, delivery schedules, restock scheduling, etc.). Monitoring inventory of products may include monitoring the number of SKUs of respective products within the retail facility 300, monitoring the location of SKUs within the retail facility 300 (e.g., backroom, sales floor, shelf, aisle 208, product drop off area 306, and so forth), ordering SKUs upon determining the number of SKUs for a product is below a threshold number, etc. In some forms, the inventory systems 116 cooperate with the cart generation systems 112 in order to allocate specific SKUs to be in a user's cart. For example, the inventory systems 116 can allocate SKUs to a person's virtual cart, a location on the sales floor, a location in a backroom, to an online order, and so forth. The inventory systems 116 may virtually allocate these products or SKUs and as a result be able to determine if an item that may be physically available in the store has been allocated for purchase by a customer and therefore unavailable to be used in an alternate transaction/order. In some embodiments, the inventory systems 116 are cooperated with the product identification systems 102 in order to allocate specific SKUs of a product with a specific location within the retail facility 300. For example, the product identification systems 102 may determine that a product resides on a specified shelf of a respective aisle 208 within the retail facility 300. The specified shelf and respective aisle 208 may be output to the inventory systems 116 and the product is allocated to said location until identified at an alternate location of the retail facility 300. The product identification systems 102 may identify the locations of SKUs of products physically located within the retail facility 300 and the locations may be output to and updated (e.g., periodically or in real time) within the inventory systems 116.

FIG. 4 shows a profile view 400 of a person 202 between two product support systems 212. In some embodiments, the person 202 is a customer, facility worker or associate, or other person in the retail facility 300. FIG. 4 further shows two cameras of the first set of cameras 204 located in an elevated position to the person 202, for example above a top surface of the product support systems 212. The cameras may be oriented and/or aimed between the product support systems 212 such that the person 202 may be in the respective fields of view 210 of one or more cameras of the first set of cameras 204. While a field of view 210 of only one camera 204 is shown in FIG. 4 for simplicity, it will be understood by those skilled in the art that each camera of the first set of cameras 204 has a respective field of view 210. In some embodiments, the person 202 may be partially in the field of view 210 of a particular camera 204 as shown, and it is understood that the remaining portion of the person 202 not in the field of view 210 shown may or may not be in one or more other fields of view 210 of one or more additional cameras of the first set of cameras 204.

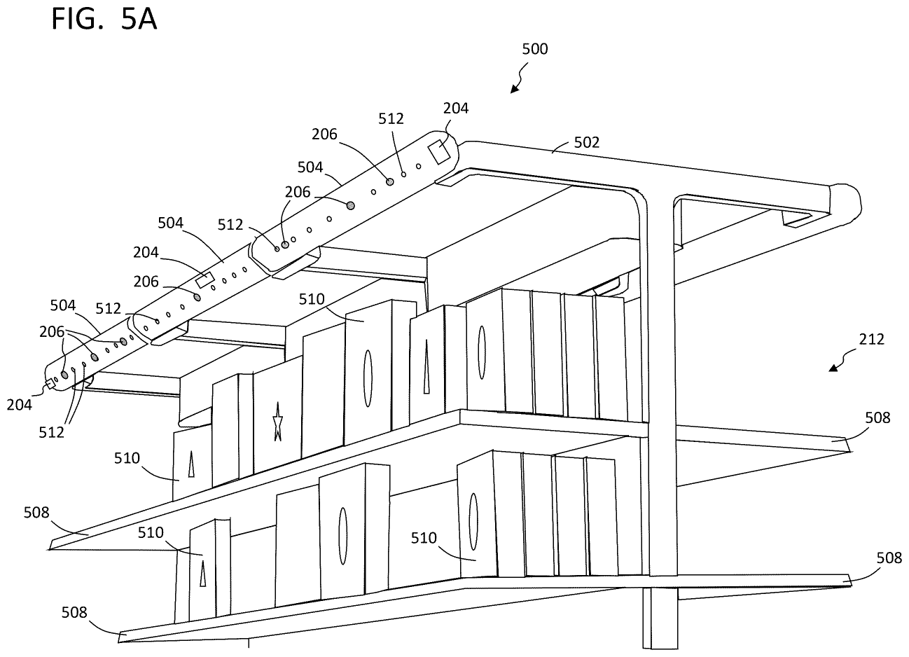

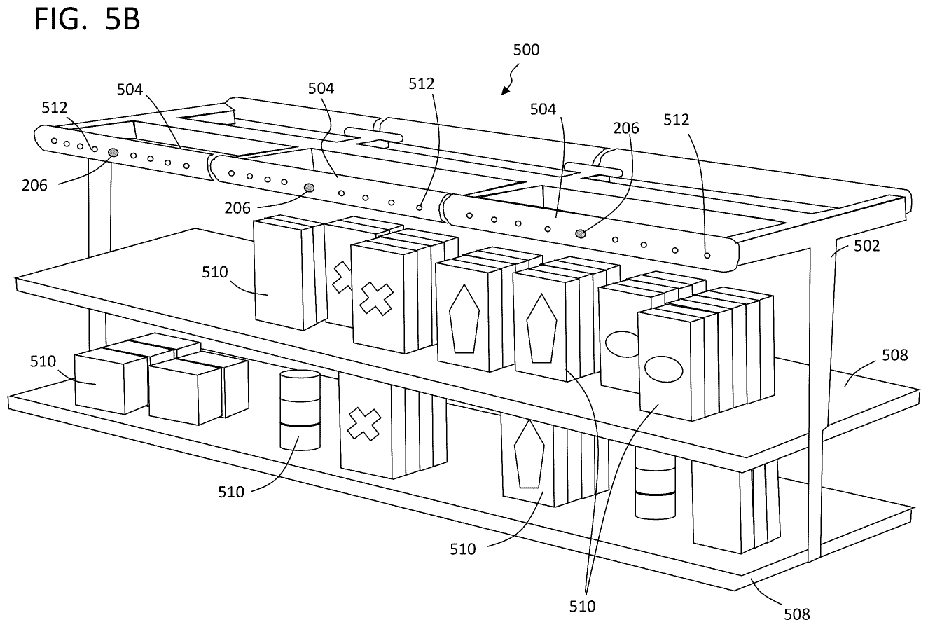

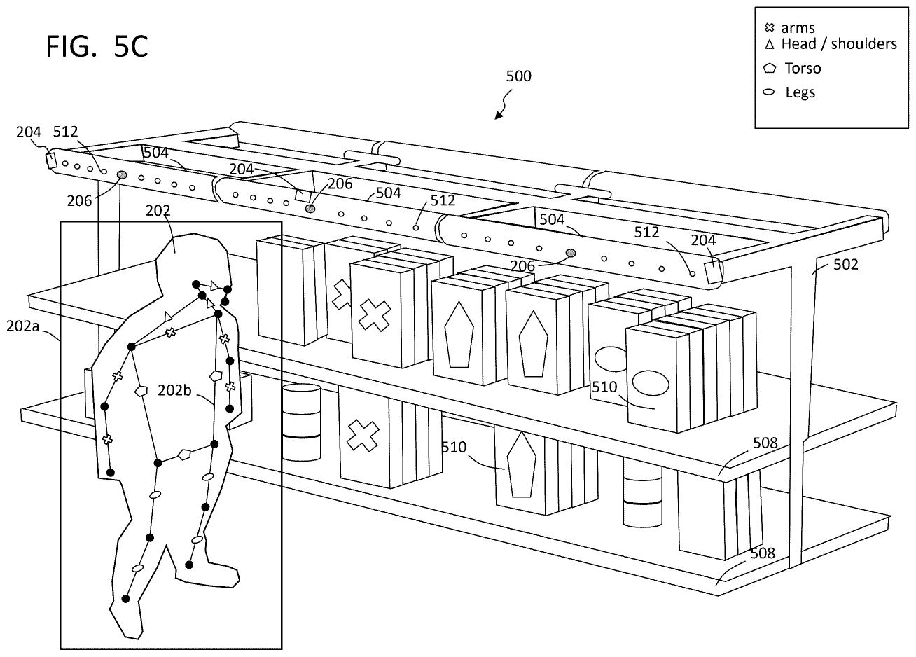

FIG. 5A illustrates an underside, perspective view of an example product identification and allocation subsystem 500 at an elevated position relative to a ground surface, in accordance with some embodiments. FIG. 5B shows an overhead, perspective view of an example product identification and allocation subsystem 500, in accordance with some embodiments. FIG. 5C shows an overhead, perspective view an example product identification and allocation subsystem 500 with a graphical representation of one characteristics and/or vectors corresponding to a person 202 in accordance with some embodiments. The product identification and allocation system 100 may be implemented through a series of product identification and allocation subsystems 500 positioned relative to and/or defining part or all of one or more zones 201. For example, a series of product identification and allocation subsystems 500 can be positioned proximate to and along one or more boundaries of a zone. In some embodiments, the product identification and allocation subsystems 500 can comprise one or more image capture beams 504, bars, and/or other such structures that comprise a housing, casing or the like with which are secured and/or positioned one or more lights 512 and/or light systems, one or more image capture systems, such as one or more cameras of the first and/or second sets of cameras 204, 206, other cameras or a combination of two or more types of camera systems, one or more sensors, other system components, or a combination of two or more of such components.

The product identification and allocation subsystem 500 can, in some embodiments be secured with and positioned above one or more product support system 212, suspended (e.g., from a ceiling or other such structure) above a portion of a zone, and/or other such configurations. In some embodiments, the image capture beams 504 are supported by sets of mounting support system 502 comprising beams, struts, posts, brackets, rails, clamps, and/or other such structures configured to position one or more of the product identification and allocation subsystem 500 (e.g., secure the product identification and allocation subsystem with a product support system 212). For example, the mounting support system 502 can include posts that cooperate with and/or are part of a product support system and extend above shelves 508 of a product support system 212 with one or more cross beams that position the image capture beams 504 at an intended location relative to the zone and product support system. The positioning of the product identification and allocation subsystem 500 can be a physical coupling of portions of the product identification and allocation system 100 to one or more product support systems 212. The supports can, in some embodiments, extend from a center line of the product support system and position the image capture beams 504 in position the first and/or second sets of cameras 204, 206 at intended vertical and horizontal orientation to a zone and/or one or more support systems.

The mounting support system 502 of the product identification and allocation subsystem 500 couple and position one or more image capture beams 504, which may include one or more cameras, lights 512, sensors, etc. The cameras may include one or more cameras of the first set of cameras 204 and/or the second set of cameras 206, such that the product identification and allocation system 100 are able to generate person identifiers of a person 202 proximate the product identification and allocation subsystem 500, and identify products 510 proximate the product identification and allocation subsystem 500., which can be utilized in generating a virtual cart associated with the person 202 and allocate identified products to said virtual cart. In some embodiments, image capture beams 504 can include at least one camera, of the second set of cameras 206, that can provide images used in product identification, and which may be positioned proximate the center of the image capture beam 504 with one or more lights 512 positioned on one or more sides of the camera. The lights 512 may be any suitable light, such as one or more LEDs, incandescent lights, light-emitting diodes, and so forth, such that the products 510 and/or people 202 within a field of view of the camera(s) can be at least temporarily illuminated. There may be any number of lights 512. In some embodiments, each image capture beam 504 may include one or more cameras of the first set of cameras 204 utilized in person identification, while in some embodiments, only a portion of the image capture beams 504 (e.g., end image capture beams 504) include cameras of the first set of cameras 204 for person identification. Any configuration of lights 512, cameras), and image capture beams 504 may be used such that intended portions or all of a zone are within a field of view of cameras.

FIG. 5C shows a person 202 proximate the product identification and allocation subsystem 500 (e.g., in an aisle 208). The view shown in FIG. 5C may be, for example, a view from a camera of a first set of cameras 204 used in person identification. A person identification system 106 may receive an image, or a series of images, from the camera, which includes a person 202 within the field of view of the camera 206 and identify and/or superimpose a boundary box 202a around some or all of the image of the person 202. Some embodiments may determine one or more vectors, characteristics, and/or motion lines over the person 202. The boundary box 202a, vectors, the motion lines, etc. can be used to track the user (e.g., generally move with movement of the person 202) such that the motion lines and/or other characteristics will correspond with the same portions of the person 202 regardless of the position of the person 202. The boundary box 202a, generated vectors, colors, patterns, motion lines and/or other such characteristics can be utilized by the person identification system 106 and/or the product identification system 102 to track movement of the person 202 relative to the products 510 and to identify when the person 202 has interacted with a product 510 to the extent that the product 510 should be allocated to a virtual cart that is associated with the zone and a user identifier. In some embodiments, the person identification system 106 may use a similar boundary box 202a, generated vectors, colors, patterns, motion lines and/or other such characteristics to identify the person 202 (e.g., by mapping relative to the person's facial features, body features, clothing features, etc.).

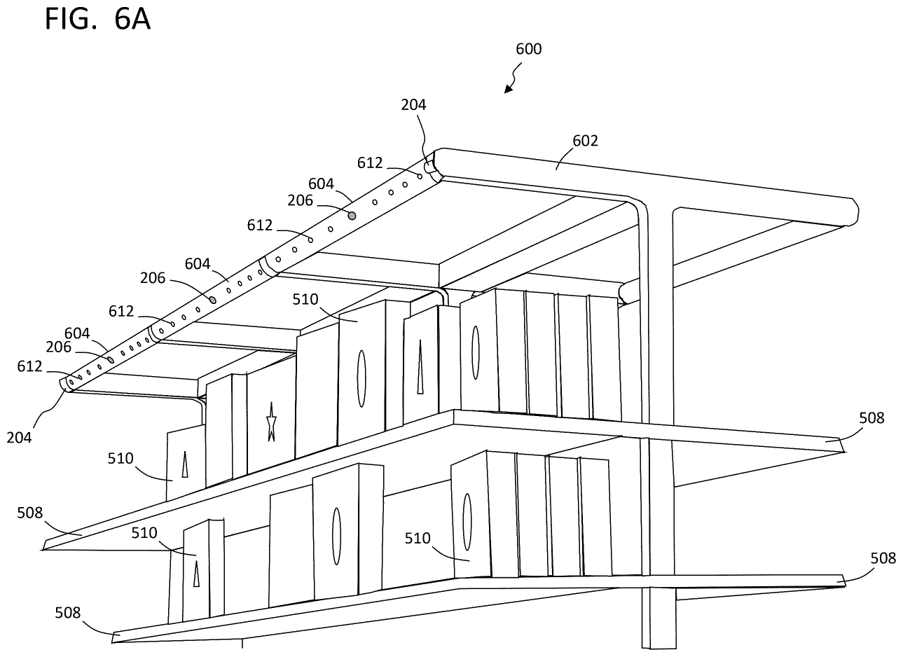

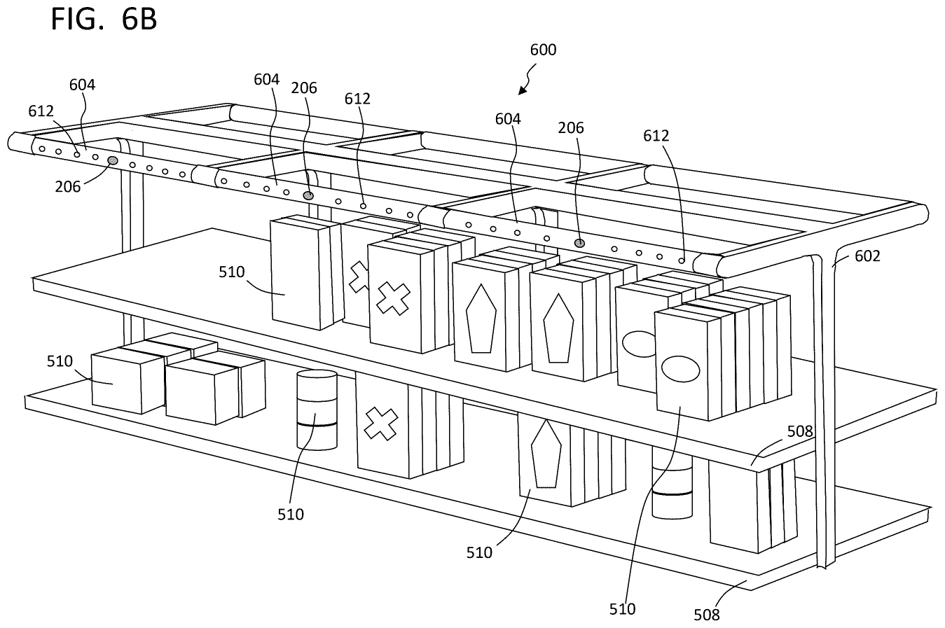

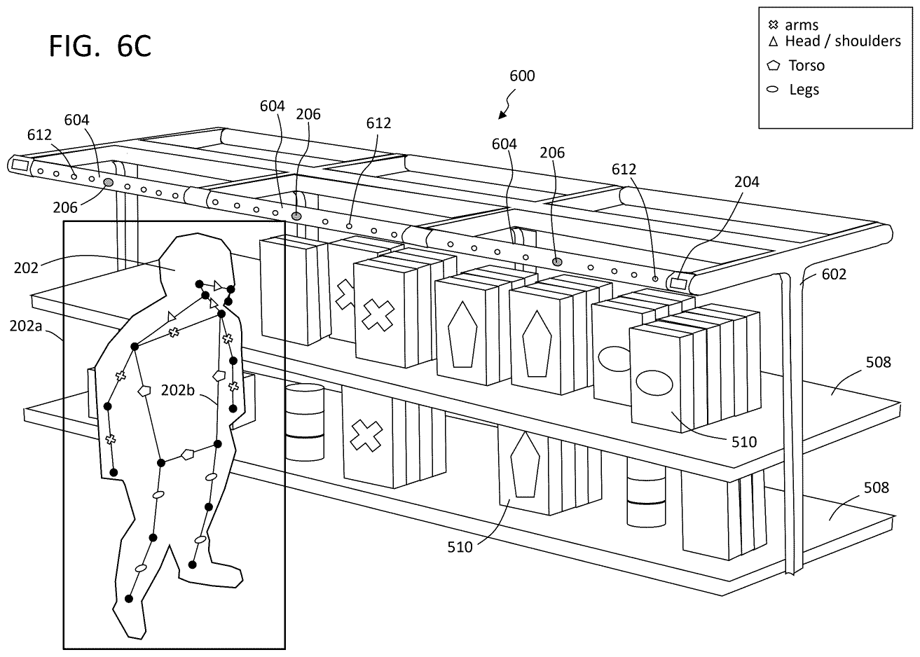

FIGS. 6A-6C show an example product identification and allocation subsystem 600 cooperated with an example product support system, in accordance with some embodiments. FIG. 6A shows an underside, perspective view of the example product identification and allocation subsystem 600. FIG. 6B shows an overhead, perspective view of the example product identification and allocation subsystem 600. FIG. 6C shows the perspective view of FIG. 6B further including an example of a person 202. As shown, the product identification and allocation subsystem 600 can be secured with and/or include one or more product support systems, which may include one or more shelves 508. The product identification and allocation subsystem 600 can include one or more camera rail systems 602 or image capture beams. In some embodiments, the product identification and allocation subsystem 600 can be configured to physical couple one or more portions of the product identification and allocation system 100 with one or more product support systems 212.

The camera rail system 602 can include one or more image capture beams 604 including at least one camera 206. In some embodiments, one or more of the image capture beams 604 may include one or more cameras of the first and/or second set of cameras 204, 206, one or more lights 612, one more sensor systems, RFID tag sensor systems, other such components or a combination of two or more of such components. The cameras may be any combination of the first and/or second sets of cameras 204, 206, and can be configured to capture images to enable the generation of a person identifier of a person 202 proximate the product identification and allocation subsystem 600 and/or identify a product 510 proximate the product identification and allocation subsystem 600, which may be used in populating a virtual cart associated with a zone and the identifier of the person 202, and allocate one or more identified products to the virtual cart that are removed from a shelf 508. In some embodiments, each image capture beam 604 can include at least one camera 206 for product identification positioned proximate the center of the image capture beam 604. One or more lights may be incorporated into the image capture beam 604, such as with lights 612 positioned on either side of the camera 206. The lights 612 may be any suitable light such as but not limited to LED, incandescent light, light-emitting diode, and so forth, such that the products 510 and/or people 202 within a field of view of the camera(s) 206 can be illuminated. There may be any number of lights 612, though the present embodiment depicts four lights 612 on either side of the camera 206 on an image capture beam 604. In some embodiments, each image capture beam 604 may include a camera 204 for person identification, while in some embodiments, only a portion of the image capture beams 604 (e.g., end image capture beams 604) include cameras of a person identification system 106. Any configuration of lights 612, cameras 206 (such as cameras 204 and cameras 206), and image capture beams 604 may be used such that all portions of an aisle 208 are in a field of view of cameras 206 for both product 510 and person identification.

FIG. 6C shows a person 202 proximate the product identification and allocation subsystem 600 (e.g., in an aisle 208). The view shown in FIG. 6C may be, for example, a view from a camera (such as a camera 204) used for person identification. The person identification system 106 may receive an image, or a series of images, from the camera 206 which includes a person 202 within the field of view of the camera 206 and define and/or superimpose the boundary box 202a around the person 202, generated vectors, colors, patterns, motion lines and/or other such characteristics relative to the person 202 as described herein.

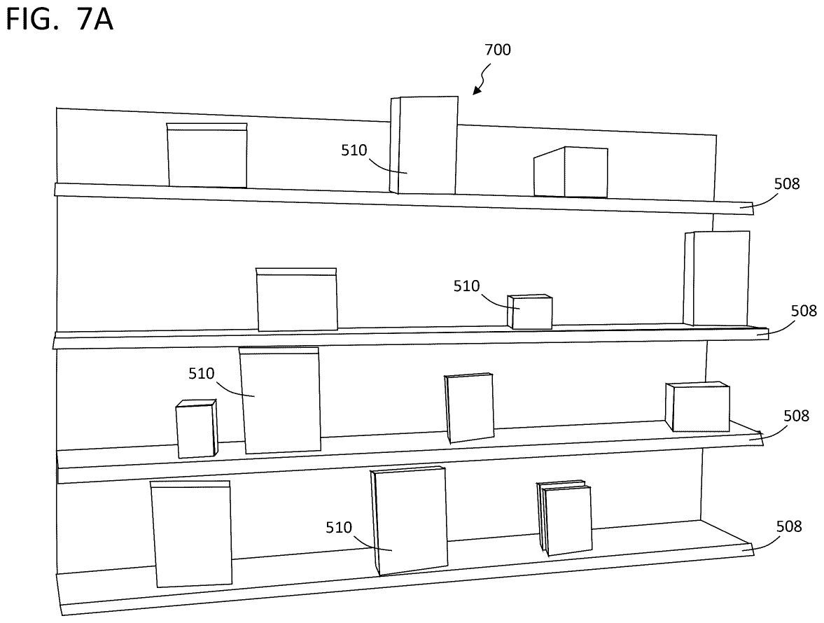

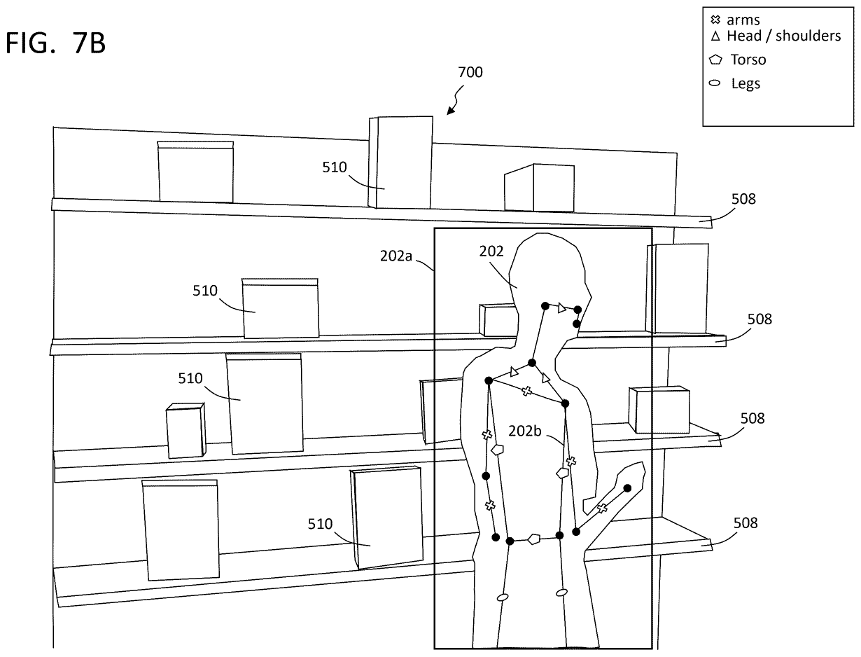

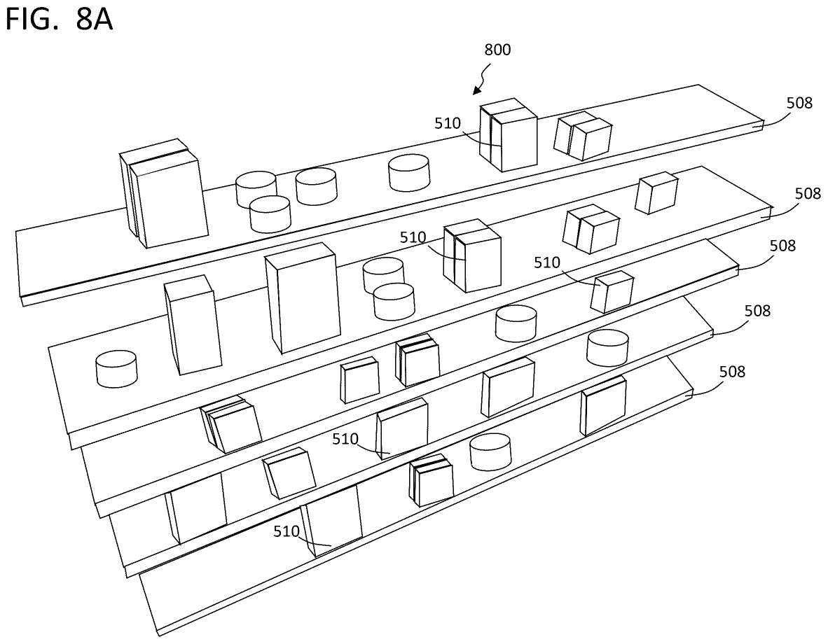

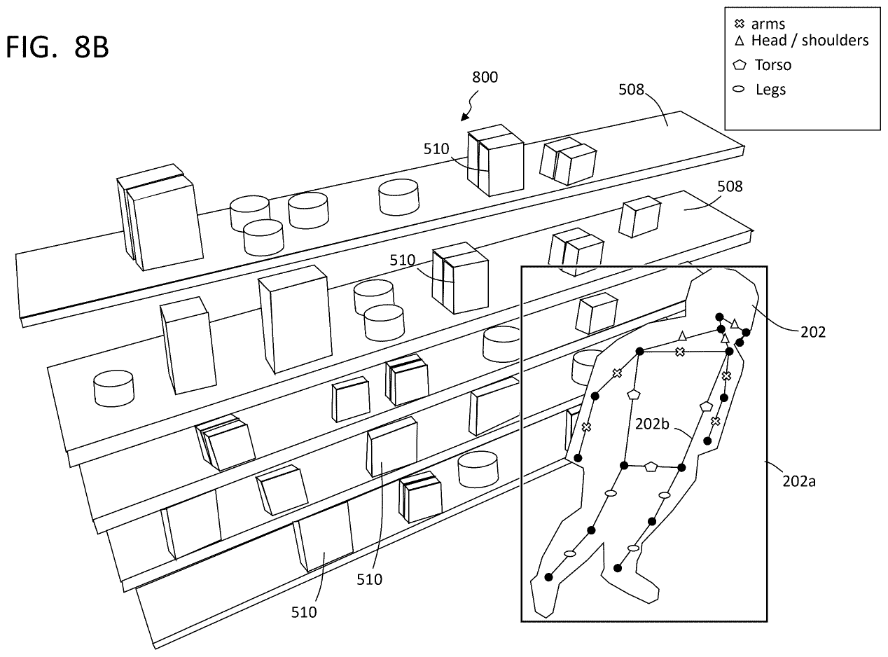

FIGS. 7A-7B and 8A-8B show respective example fields of views 700, 800 from one or more cameras (e.g., cameras 204, 206) of shelves 508 holding products 510 in accordance with some embodiments. FIGS. 7A and 8A each show the view 700, 800 of a series of shelves 508 (e.g., a product support system 212) holding products 510. FIGS. 7B and 8B show the views of FIGS. 7A and 8A respectively, further including a person 202 as viewed by a respective camera. In some embodiments, the person identification system 106 can distinguish the person from the surroundings (e.g., define a boundary box 202a about some or all of the person) and/or can determine one or more characteristics of the person (e.g., define one or more vectors, motion lines, detect patterns, other characteristics, etc.) as described herein.

Referring back to at least FIGS. 1-3C, in some embodiments the product identification and allocation 100 includes one or more zone allocation systems 126 that can comprise one or more zone allocation control circuits 146 that can executing a zone allocation code set 147, and can communicatively couple with one or more components of the product identification and allocation system 100 and/or other components external to the product identification and allocation system 100. The zone allocation systems 126 typically is communicatively coupled with an inventory database 104, and when executing the zone allocation code set 147 can be configured to define at least a subset of and typically all of the multiple zones 201. Establishing the zones can in part greatly simplify the computational processing, in some applications greatly simplify the complexity of product identification, improve the accuracy of product identification, and/or other such benefits. In some embodiments, the zone allocation systems 126 can define two or more zones 201 by restricting a numbers of different products, each having a different unique product identifier (e.g., different stock keeping unit (SKU)), within the respective zone as a function of densities of product identifiers within different sections of the retail facility. In some embodiments, the zone allocation control circuit executing the zone allocation code set, in defining the multiple zones 201, can be configured to initiate one or more zone segmentation/allocation machine learning models applied to and based on inventory data (e.g., in the inventory database), product location mapping, the product identifiers, other such product data or a combination of two or more of such product data, that can define recommended zone boundaries based on location of products. In some embodiments, the one or more zone allocation machine learning models can be trained based on a zone corpus of information such as product locations, product densities, rates of sales, product demand, size of products, physical characteristics of products, other such factors, or a combination of such factors, and is retrained over time based in part on feedback of subsequent accuracy and/or inaccuracy of product identifications within respective zones providing modified zone allocation machine learning models.

This product restriction can additionally or alternatively be established based on one or more threshold densities of different products, a threshold quantity of different products, one or more threshold variations and/or lack of variations in product appearance and/or physical characteristics, other such factors, or a combination of two or more of such factors. Further, the restriction of the different products within a zone 201 can in part improve the performance of the product identification system 102. In some embodiments, the product identification system 102 corresponding to a specific zone 201 can apply one or more machine learning product identification models that are trained with a corpus of data, images, product characteristics and/or other such factors restricted to the products expected to be positioned within the particular zone 201. As such, respective product identification machine learning models can each be trained based on a restricted corpus of product information constrained to information corresponding to a restricted set of potential products assigned to be, potentially assigned to be and/or expected to be positioned within the specific zone 201. Further, these product identification machine learning models are retrained over time based on feedback from identification of products by the zone product identification machine learning model, feedback from users in response to incorporation into a virtual cart, feedback from a purchasing system, changes to products within the zone, and/or other relevant information to result in respective modified product identification machine learning models that are expected to have more accurate results. The application of machine learning in previous systems were adversely affected by the training of products of an entire retail store or large quantity of different products. By limiting the training corpus and retraining to a threshold number of products or SKUs, the trained product identification models of some embodiments the models provide greater accuracy in identifying products that have been removed and/or taken by a person from a zone 201. Accordingly, some embodiments utilize different product identification models for the different zones 201, with each model trained and retrained relative to the limited number of products expected to be positioned within the zone with which that model is associated. In some embodiments, the product identification system 102 does not attempt to detect the hand movement of a person as the person removes the product/item or to detect that movement of the product being removed, and instead detects that one or more products (or a quantity of products) has been removed based on differences in the products between two sets of one or more pictures captured at different times. A person having been proximate the location of the removed product can be associated with that removed product.

In some embodiments, the control circuit 101 associated with a particular first zone, in executing the product identification code set in identifying the first product, can detect or determine a difference in a number of products within the first zone by comparing a preceding first subset of product images of products within the first zone, which may have been captured before a threshold first period of time has elapsed, to a subsequent second subset of product images of the first zone, which may have been captured after the threshold first period of time has elapsed. The difference can detect, for example, a vacant space on the product support system, a change in count of products, a change in color tone, a change in other such detections, or a combination of two or more of such detected differences. In some embodiments, one or more machine learning product identification models are applied to detect the differences, and/or other known techniques are utilized to detect the differences corresponding to a product having been removed from a product support system. Based on this difference one or more products and a quantity of the one or more products can be identify that are determined to have been removed based on the determined difference in the number of products within the first zone. These removed products can be associated with one or more people within the zone and having threshold relationships with one or more of the removed products. In some embodiments, the product identification system can determine that a first person was within a first threshold distance of a removed product and, at or after the threshold first period of time, that the first person is at least a threshold first distance from a portion of product support system where the first product was removed. The zone virtual cart generation system 112 can utilize, through a control circuit 101 executing the zone cart generation code set 142, the association of the first customer with the first product removed from the product support system to virtually add the first product to a first virtual zone cart that is exclusively associated with the first person identifier, and typically the first zone 201.

In some embodiments, the execution of the product identification code set 132 can initiate a first zone product identification machine learning model, of multiple different zone product identification machine learning models each associated with a different one of the multiple zones 201, to identify one or more products, of the set of products within the first zone, that is determined to have been removed from the product support system by a person. The identified one or more products can be associated, by the control circuit executing the zone cart generation code set, to virtually add the identified one or more products to a zone virtual cart that is associated with the person identified through the execution of the person identification code set, predicted to have removed the one or more products.

The product identification and allocation system 100 can, in some embodiments, automatically utilize the cumulative virtual cart and/or one or more zone virtual carts to complete a purchase transaction without the customer having to go to a point-of-sale (POS) system 130 (e.g., store associate operated POS, self-checkout POS, etc.) or other such physical station within the retail facility, enabling an automated Just-Walk-Out experience for customers. In some embodiments, one or more purchase control systems 128 executing purchase code set 152 can automatically access the cumulative virtual cart corresponding to the first person, for example stored in a virtual cart database and/or customer database maintaining customer profiles and other information associated with a customer. The cumulative virtual carts may be stored in one or more computer memory systems of the facility (e.g., one or more databases 104), and/or remote memory storage. With a respective cumulative virtual cart, the purchase control system 128 can control one or more payment acquisition systems (e.g., credit card systems, touchless payment systems, payment through a virtual account, etc.) to obtain payment for each product identified within the cumulative virtual cart. In some embodiments, the purchase control system 128 can generate a confirmation notification in based on receiving and/or confirming receipt of payment, and automatically control a graphical user interface of a user computing system 114 (e.g., smartphone, tablet, computer, and/or other such consumer electronic device) associated with the first person to render a payment confirmation interface comprising confirmation in a predefined, standard format that comprises a confirmation information that is machine readable via one or more systems (e.g., barcode scanner system and/or application, QR code scanner and/or application, etc.). In some embodiments, when a person 202 exits the retail facility 300, the purchase control systems 128 automatically obtains payment for the products in the cumulative virtual zone cart automatically completing purchases of these products using one or more payment methods associated with the person 202. The purchase control system 128, in some embodiments, obtains an identifier of the person corresponding to the person identifier (e.g., through an application executed on a user computing device 114, a customer identifier, etc.), and accesses a user profile corresponding to the identified person to obtain one or more methods of payment that are utilized in automatically obtaining the payment. The purchase control system 128 can be implemented through one or more purchase control circuits 150, implemented through one or more processors, microprocessors, ASICs, control logic, computers, servers, and/or other such system, that execute the purchase control code set 152.

In some embodiments, the product identification and allocation system 100 can include one or more checkout person identification systems 130 that can comprise one or more checkout person identification control circuits 156 that communicatively coupled with one or more computer readable tangible medium storing a checkout person identification code set 158 that is executable by the one or more checkout person identification control circuits 156. A checkout person identification system 130 and/or one or more checkout person identification control circuits 156 can associated with one or more checkout zones 330 of a retail facility 300, and in some embodiments includes and/or is in communication with one or more sets of checkout camera systems 331 and/or other sensors 332 (e.g., RFID tag readers, barcode readers, kiosks, terminals and/or other systems) that can capture identifying information of a person.

In some embodiments, the checkout person identification system 130 can be configured to detect, through one or more checkout cameras 331 and/or other sensors 332, a person approaching, within and/or exiting the respective checkout zone 330 and in response generate a unique checkout person identifier of the person approaching, exiting and/or within the checkout zone. For example, the checkout person identification system 130 may include one or more person identifier systems 106 that can generate a checkout person identifier based on a set of checkout person images captured by checkout cameras. The checkout person identifier can be associated, in some embodiments, with a first person identifier, such as in response to confirming the checkout person identifier is within an identifier threshold difference of the first person identifier. Additionally, in some embodiments, the checkout person identification system 130 can confirm payment each of the products identified within a cumulative virtual cart associated with the first person identifier, such as in response to a user presenting a machine readable confirmation of payment to a scanner system, when the checkout person identifier is within the identifier threshold difference of the first person identifier, associating content of a physical cart with a cumulative virtual cart, other such confirmation of identification and/or a combination of such confirmation.

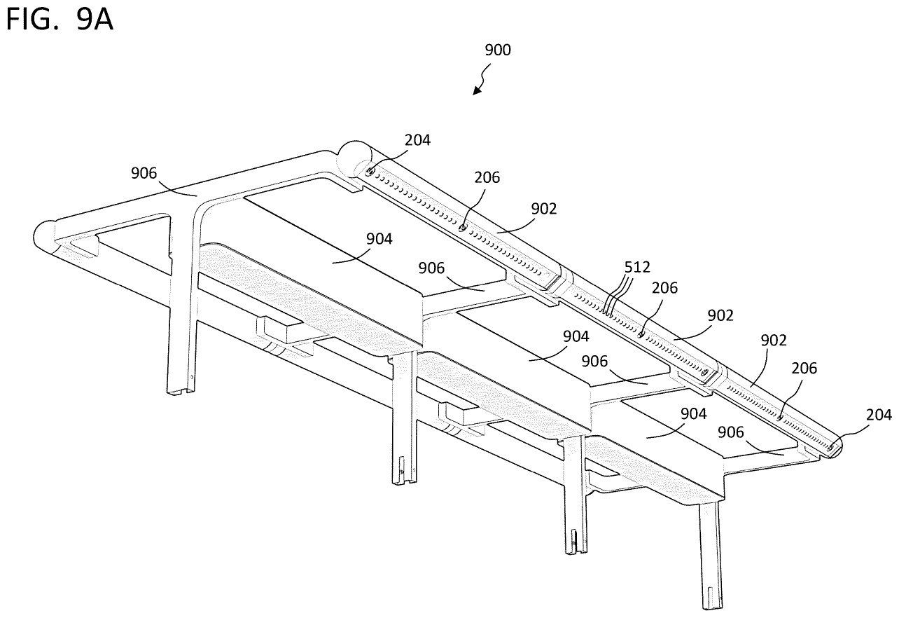

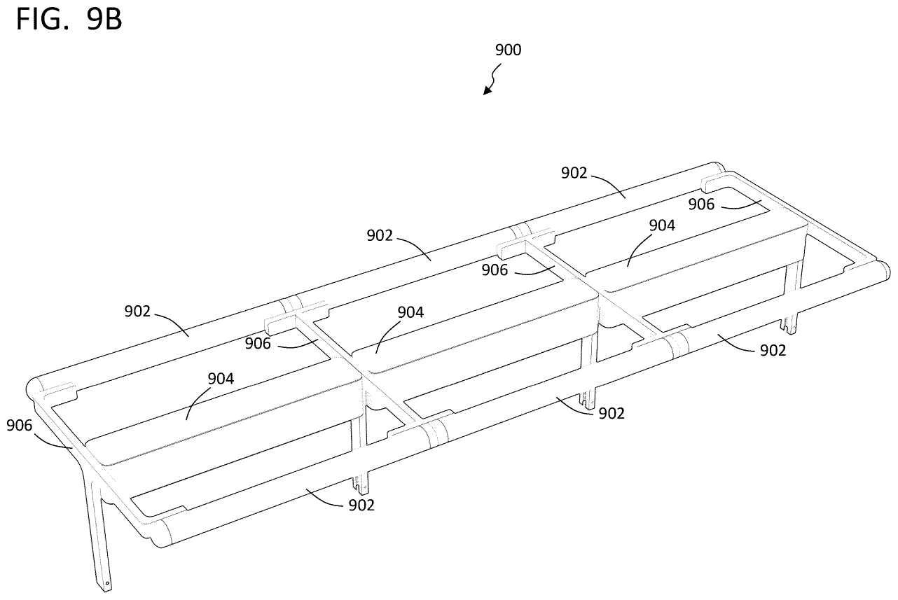

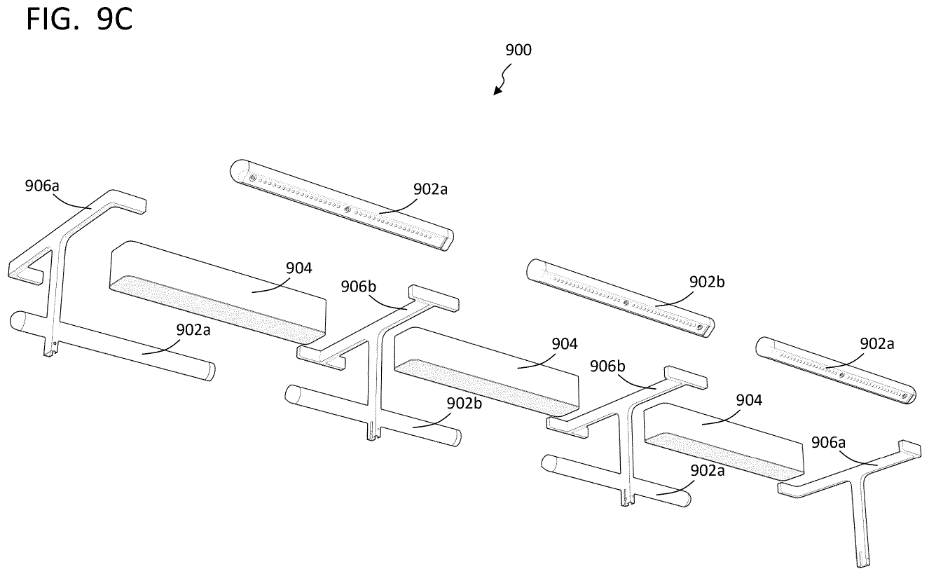

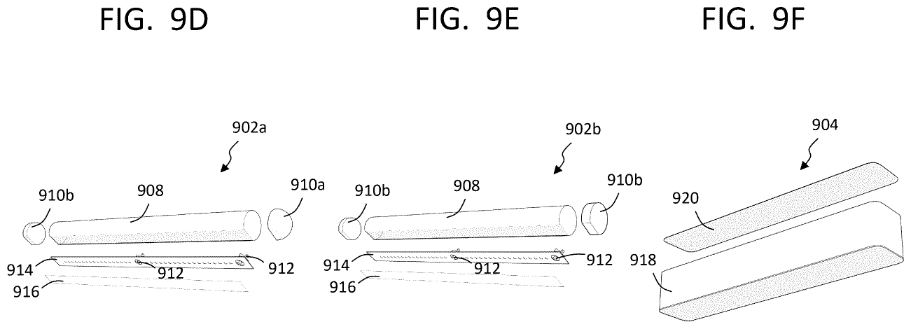

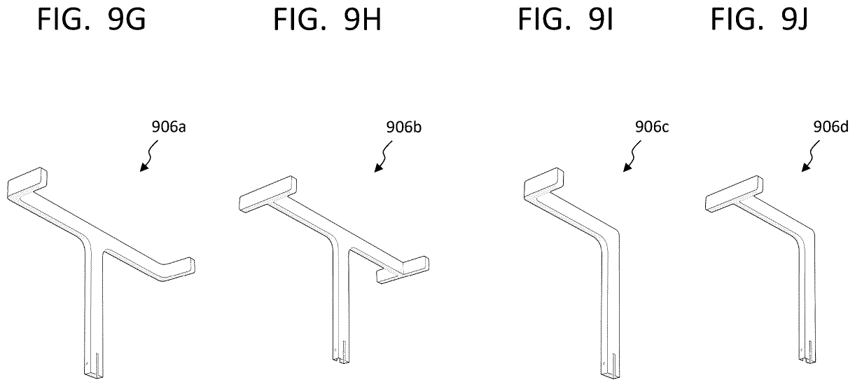

FIGS. 9A-9J show an example product identification and allocation subsystem 900 and portions thereof, in accordance with some embodiments. In some forms, the product identification and allocation subsystem 900 is the same or similar to the product identification and allocation subsystem 200, the product identification and allocation subsystem 500, and/or the product identification and allocation subsystem 600. FIG. 9A shows a perspective view of the product identification and allocation subsystem 900 from an upwards angle relative to a ground surface and FIG. 9B shows a perspective view of the product identification and allocation subsystem 900 from a downwards angle relative to the ground surface. FIG. 9C shows an exploded perspective view of the product identification and allocation subsystem 900 from an upwards angle relative to a ground surface. The product identification and allocation subsystem 900, in some embodiments, is configured to physically couple with a product support system 212. Generally, the product identification and allocation subsystem 900 includes one or more camera rails 902 (which may be the same or similar to the camera rail system 502 and/or the camera rail system 602), component housings 904, and connectors 906.

In some embodiments, the camera rails 902 are interchangeable and/or are the same and cooperate with and can be secured in positioned by one or more connectors 906 and/or one or more adjacent camera rails. As shown in the exploded view of FIG. 9C, the camera rails 902 be defined as end camera rails 902a and middle camera rails 902b. In some embodiments, an internal end of a camera rail (e.g., an end camera rail 902a) couples to an adjacent internal end of a neighboring camera rail 902 (e.g., the internal end of another end camera rail 902a or an end of a middle camera rail 902b), and an external end of an end camera rails 902a may not couple with an additional camera rail 902. A middle camera rail 902b can be secured in position through one or more connectors 906b. Further, a middle camera rail 902b may not couple with a neighboring camera rail. In some embodiments, one or more middle camera rails 902b are configured such that either end of the middle camera rails 902b can be coupled to an adjacent camera rail 902 (e.g., an internal end of an end camera rail 902a or an end of another middle camera rail 902b). While the present embodiment shows two end camera rails 902a on either end of a middle camera rails 902b, it is generally understood that any alternate configuration may be used (e.g., two end camera rails 902a and no middle camera rails 902b and/or more than one camera rails 902).

FIGS. 9D and 9E show exploded views of an end camera rail 902a and a middle camera rail 902b respectively. Each of the camera rails 902a, 902b can include one or more rail housings 908, casings or the like, one or more camera 912 (e.g., the cameras 204, 206), one or more slotted attachment 914, one or more camera covers 916, sensor systems, lights (e.g., secured with the slotted attachment 914), other such components, or a combination of two or more of such components. In some embodiments, the rail housing 908 includes one or more light sources (e.g., the lights 512, 612) and the slotted attachment 914 is coupled to the rail housing 908. One or more cameras 912 can be cooperated with the rail housing. Additionally or alternatively, the slotted attachment 914 can in some implementations further couple to one or more cameras 912 such that the camera 912 is coupled to the rail housing 908 via the coupling of the slotted attachment 914 to the rail housing 908. A camera 912 can be positioned at substantially any desired location along the rail housing, and in some implementations may be coupled to a middle portion of the slotted attachment 914 and/or at least one end portion of the slotted attachment 914. The camera cover 916 may protect the at least one camera 912, for example, from outside debris, human contact, etc. The camera cover 916 may in some embodiments be a clear plastic or glass which does not impede the field of view of the camera 912. It is generally contemplated that in some embodiments the camera rails 902 may not include the slotted attachment 914, the camera cover 916, and/or the light source described, and that at minimum the camera rails 902 include the rail housing 908 coupled (directly or indirectly) with at least one camera 912. FIG. 9D shows an example of the end camera rail 902a which further includes an end rail connector 910a and a middle rail connector 910b. The rail connectors 910a, 910b can coupled to either end of the rail housing 908, the middle rail connector 910b can be configured to couple with an additional camera rail 902. The end rail connector 910a may not be configured to further couple with a camera rail 902. FIG. 9E shows an example of a middle camera rail 902b which includes two middle rail connectors 910b such that one middle rail connector 910b can be on either end of the rail housing 908.

FIG. 9F shows an exploded view of an example component housing 904 of a product identification and allocation subsystem 900, in accordance with some embodiments. The component housings 904 can further include a housing 918, and in some instances a cover 920. One or more components of the product identification and allocation system 100 can reside within the housing 918 of the component housing 904. For example, one or more control circuits, computer memory, control circuits, switches, sensor systems, power sources and/or other such components of one or more product identification systems 102, person identification system 106, cart generation systems 112, other systems of the product identification and allocation system 100, other system components of other systems of the facility, or a combination of two or more of such systems, may be physically housed within the housing 918 and optionally covered by the cover 920. The housing 918, while shown as rectangular with rounded corners, may be any relevant shape and/or size configured to hold the desired components of the product identification and allocation system 100. The housing 918 is generally hollow with one open side which can be enclosed by a cover 920 with a corresponding size and shape.

FIGS. 9G-9J shows example embodiments of connectors 906, in accordance with some embodiments. The connectors 906 can configured to couple to one or more of the camera rails 902, the housings 904, and in some embodiments product support systems 212. FIG. 9G shows an example double-sided end connector 906a configured to connect to two end camera rails 902a (e.g., on opposing sides of a product support system), such that aisles 208 on both sides of a product support system 212 can viewed by the cameras 912 of the respective end camera rails 902a. In some embodiments, one end camera rail 902a may be adjacent to a first aisle 208 on a first side of the product support system 212 and the product identification and allocation subsystem 900, and a second end camera rail 902a may be adjacent to a second aisle 208 on a second side of the product support system 212 and product identification and allocation subsystem 900. Similarly, an example double-sided middle connector 906b shown in FIG. 9H, in accordance with some embodiments, and can be configured to couple to one or two middle camera rails 902b such that an aisle 208 on either side of a product support system 212 is viewable by cameras 912 of respective middle camera rails 902b. FIG. 9I shows an example single-sided end connector 906c configured to couple with one end camera rail 902a, and FIG. 9J shows an example single-sided middle connector 906d configured to couple with one middle camera rail 902b. In some embodiments, a product support system 212 may include products on one side of the product support system 212 and not the other, consequently a single camera rails 902 may be positioned on one side of the product support system 212. In some embodiments, the single-sided connectors 906c, 906d may be coupled with a product support system and/or an additional single-sided connector 906c, 906d in order to couple two camera rails 902 on opposing sides of the product support system and view an aisle 208 on either side of the product support system 212.

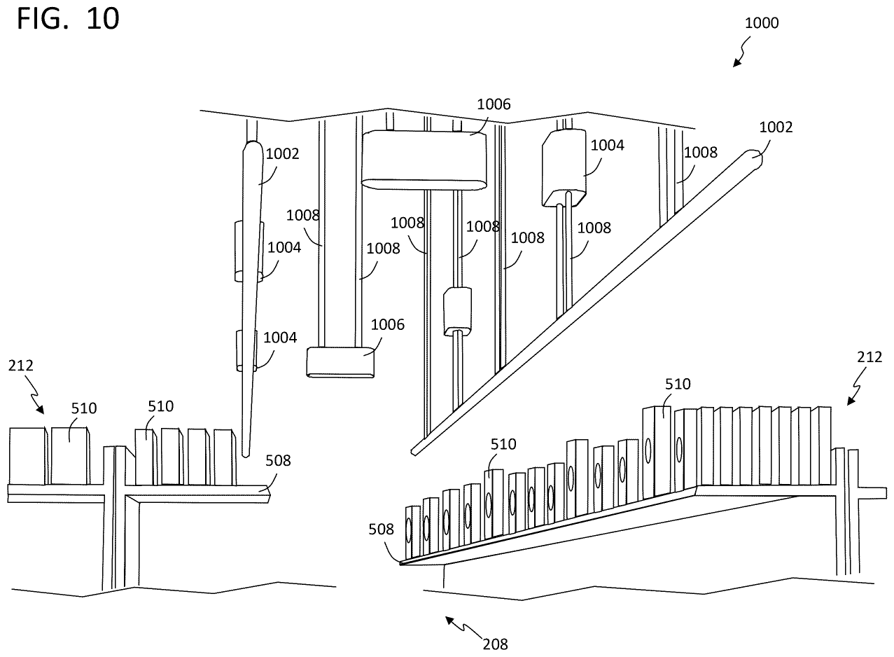

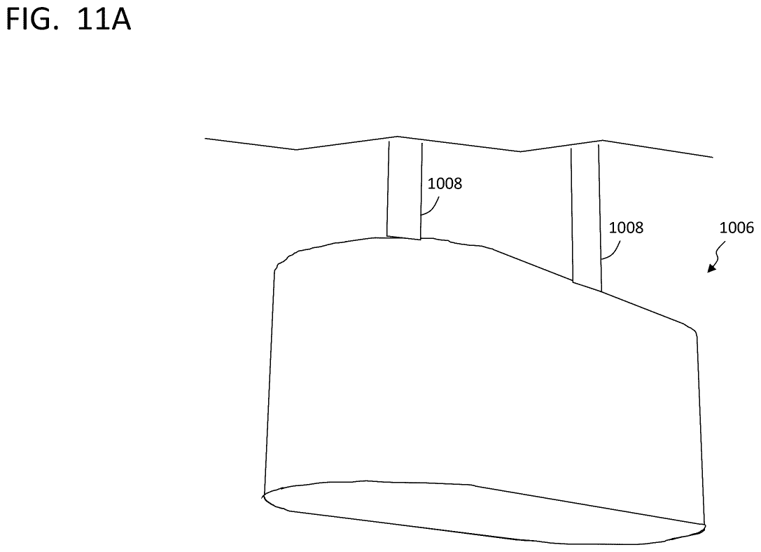

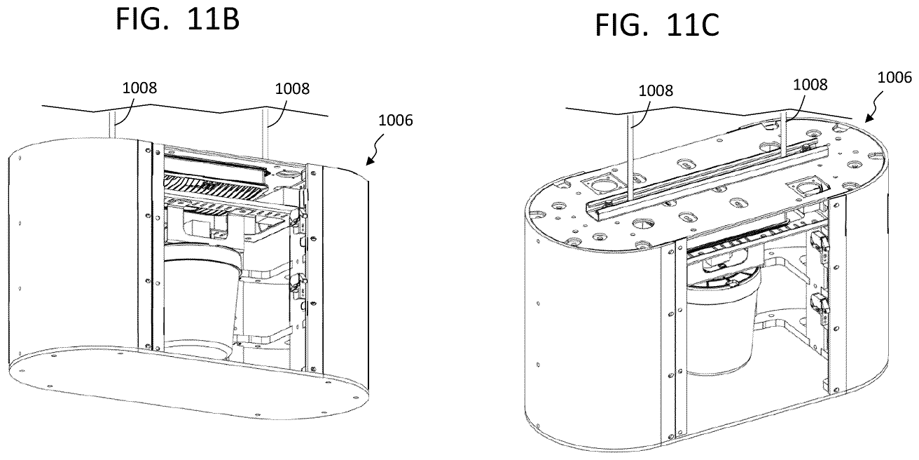

FIGS. 10 and 11A-11C show an example product identification and allocation subsystem 1000 of part of a product identification and allocation system 100, in accordance with some embodiments. The product identification and allocation subsystem 1000 shown may be hung from a surface above one or more product support systems 212 and/or aisles 208 rather than be directly coupled to a product support system 212. As shown in FIG. 10, the example product identification and allocation subsystem 1000 is hung above an aisle 208 formed between to product support systems 212 each having one or more shelves 508 supporting one or more products 510. The product identification and allocation subsystem 1000 can include supports 1008, one or more camera rails 1002 (which in some implementations may be the same as or similar to one or more of the camera rail system 502, camera rail system 602, or camera rail 902), one or more component housings 1004, one or more sensor housings 1006, and. The product identification and allocation subsystem 1000 is generally configured such that cameras (e.g., cameras 204, 206, 912) of the camera rail 1002 can be oriented to align respective fields of view along respective portions of the respective zone and/or product support system 212. For example, cameras of the first and second sets of cameras 206 can be oriented to capture images of products 510 on one or more of the shelves 508 and/or people 202 within an aisle 208. The supports 1008 may be wires, beams, other such supports, a combination of two or more of such connectors that can connect components of the product identification and allocation subsystem 1000 to a support structure, and that support the components of the product identification and allocation subsystem 1000. One or more component housings 1004 may, for example, house components of the product identification and allocation system 100 such as control circuits, computer memory, control circuits, switches, sensor systems, power sources and/or other such components of one or more product identification systems 102, person identification system 106, cart generation systems 112, other systems of the product identification and allocation system 100, other system components of other systems of the facility, or a combination of two or more of such systems. The component housing 1004, in some embodiments, may be similar to the component housings 904 described herein.

FIGS. 11A-11C show a perspective view of an example sensor housing 1006 of a product identification and allocation subsystem 1000, in accordance with some embodiments. The sensor housings 1006 may, for example, house RFID readers (or alternate product identification readers/scanners), motion sensors, light sensors, and/or other relevant sensors, which may cooperate with a product identification system 102, a person identification system 106, a camera system, a lighting system, and/or other systems of a product identification and allocation system 100 and/or the facility. One or more supports 1008 can couple with the sensor housings 1006 enabling coupling of the sensor housing to a support surface of the facility, a camera rail 1002, a product support system 212, other structure, or two or more of such structures. FIG. 11A shows a perspective view of the example sensor housing 1006 from an upwards angle relative to a ground surface. FIGS. 11B-11C show partially exposed, perspective views of an example sensor housings 1006 from an upwards view and a downwards view, respectively, relative to a ground surface, and further show an example of components housed inside the sensor housings 1006. FIGS. 11B-11C are examples, and there may be any additional or alternate components or configurations of components within the sensor housings 1006.

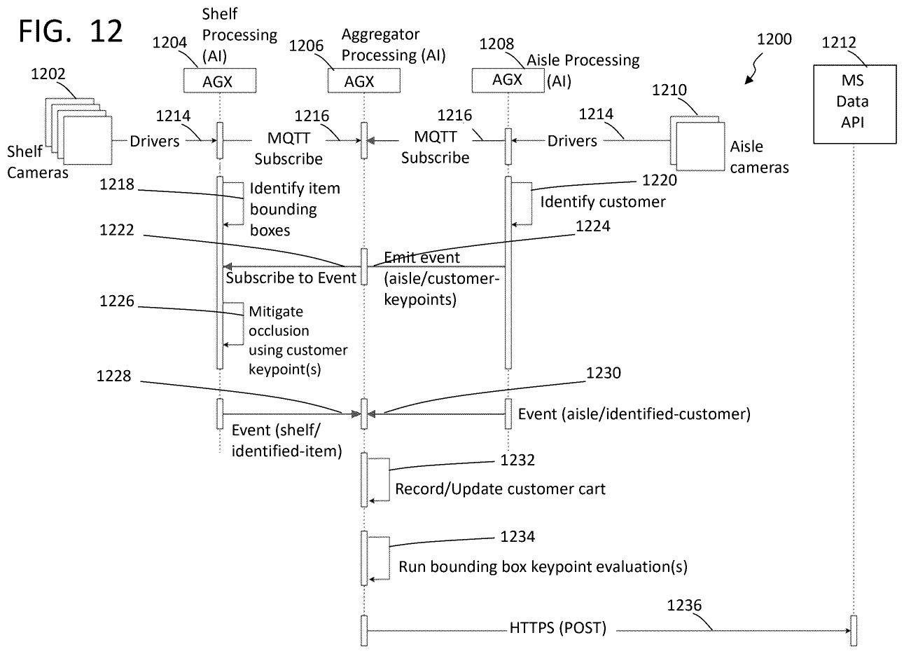

FIG. 12 shows an example architectural flow diagram of an example process 1200 of product identification and allocation by a product identification and allocation system 100, in accordance with some embodiments. The product identification and allocation system 100 can include shelf cameras 1202 of the second set of cameras 206 configured to capture images of products. Control circuits 101 executing the product identification code set 132 of a product identification system 102 can perform product identification processing 1204. In some embodiments, the product identification control circuit(s) can comprise one or more processors, microprocessors, ASICs, computer logic, other such systems or a combination of two or more of such systems, which can execute the product identification code set(s), and in some implementations may be implemented in part or full through a Navidia AGX, and/or other similar processing systems, computing boards, system on chip (SoC) systems, system on module (SoM) systems, etc.). In some embodiments, control circuit(s) implements some and/or all of a product identification system 102 configured to perform some or all aspects of the product identification. The shelf cameras 1202 of the second set of cameras 206 are communicatively coupled (e.g., wired and/or wirelessly coupled through one or more transceivers and/or drivers 1214) to the shelf and/or product identification processing 1204. The drivers 1214 can comprise software code and/or programs executed by a control circuit and configured to connect hardware elements to a computing system (e.g., the shelf cameras 1202 to the product identification control circuit(s)).

In some embodiments, the architecture 1200 can further include one or more aisle cameras 1210 (which may comprise the cameras of one or more sets of the first set of cameras 204) configured to capture images of people 202 within one or more zones that can be accessed by a person identification system 106 to implement person identification processing 1208. In some embodiments, the person identification system can comprise and/or be implemented through one or more processors, microprocessors, ASICs, computer logic, other such systems or a combination of two or more of such systems, which can execute the person identification code set(s), and in some implementations may be implemented in part or full through a Navidia AGX, and/or other similar processing systems, computing boards, system on chip (SoC) systems, system on module (SoM) systems, etc. In some embodiments, the person identification processing 1208 implements some and/or all of a person identification system 106 configured to perform some or all aspects of the person identification. In some embodiments, the aisle cameras 1210 can be communicatively coupled 1214 (e.g., wired and/or wirelessly coupled through one or more transceivers and/or drivers) to and/or images can be accessed from one or more storage memory by the person identification system 106. Images are processed to identify customers 1220.

Still referring to the example of FIG. 12, in some embodiments the architecture 1200 further includes one or more cart generation systems 112 that can implement cart generation processing 1206. The control circuit(s) 101 can comprise one or more processors, microprocessors, ASICs, computer logic, other such systems or a combination of two or more of such systems, which can execute the zone cart generation code set(s), and in some implementations may be implemented in part or full through a Navidia AGX, and/or other similar processing systems, computing boards, system on chip (SoC) systems, system on module (SoM) systems, etc. The cart generation processing 1206, in some embodiments, implements some or all of the population of one or more virtual carts and/or virtual cart generation of the virtual cart generation system 112 configured to perform some or all aspects of the zone cart implementation. The cart generation system can in some embodiments be communicatively coupled (e.g., wired and/or wirelessly coupled through one or more transceivers and/or drivers) to the product identification system 106 and/or the person identification system 106, or to computer memory storing product identification information and/or person identification information. In some embodiments, a message queuing telemetry transport (MQTT) subscribes 1216 the cart generation system 112 with the product identification system 102 and/or the person identification system 106. In some aspects, the MQTT subscribe 1216 is software that establishes a communication and/or controls communication connects between the cart generation system 112 with the person identification system 106 (or person identification information) and the product identification system 102 (or product identification information).

In some embodiments, one or more control circuits 101 in executing the product identification code set 132 can be configured to receive images from one or more of the shelf cameras 1202 and identify positions in a product support system 212 of one or more products positioned within the product support system of a zone, for example by defining or creating item bounding box 1218 around a respective products in the image(s). In some embodiments, one or more machine learning product identification models can be applied to the one or more images to detect differences between images in detecting a removal of a product and/or a quantity of two or more products from a respective product support system. The same or different product identification machine learning models can, in some embodiments, be applied relative to individual products detected in an image to obtain a predicted product identification of the respective product. This can be performed for each product detected within an image and/or set of images, and subsequently used to identify one or more removed products. In some embodiments, a control circuit 101 in executing the person identification code set can be configured to access and/or receive images from the aisle cameras 1210 and can be configured to detect from the one or more images one or more events 1224 corresponding to a person in the zone that correspond to product removal from a product support system and/or return to the product support system, and/or other such events. Events 1224 may additionally or alternatively be triggered by one or more other sensors, time thresholds, distance thresholds, and/or other such triggers. In some embodiments, the person identifying system applies one or more machine learning person evaluation models to identify relevant events. The person identification processing can provide or emit the event 1224 which can include, for example, a zone identifier and/or aisle identifier in which the customer is positioned, product support identifier, one or more person characteristics and/or key points (e.g., vectors, motion lines, color pattern information, etc.) of the person, and/or other such information. The emitted event can be received by the product identification system 102 and/or the cart generation system 112 (e.g., trigger the product identification system subscribed to the event 1222). In some embodiments, the product identification system 102 and/or the person identification system can mitigate occlusion 1226 (e.g., of products hidden behind a person) through the processing of images from multiple different shelf cameras 1202 and/or aisle cameras 1210, which may be based on detected person key points and/or characteristics.

The product identification system can identify a product removed (and/or returned) based on a detection of a position in a product support system that is different than one or more previous images of the position corresponding to a product having been removed, and issue a product event 1228. In some embodiments, the product identification system may send the identified product information, and in some implementations other identifying information (e.g., shelf identifier, position identifier, etc.) to and/or is accessible by the cart generation system 112. The person identification processing 1208 can provide a person identification event 1230, which may include sending the person identifier, and in some instances additional information (e.g., other person identifying characteristics, aisle information, etc.) to and/or is accessible by the cart generation system. In some embodiments, the person identifying system applies one or more machine learning person identifier models to the one or more images to generate the unique person identifier of the person captured in the one or more images. Using this information, the cart generation system can create and/or update 1232 a virtual cart corresponding to the unique customer identifier to incorporate product information (e.g., product identifier, product description information, product quantity information, etc.) into the virtual cart. In some embodiments, the cart generation system maintains and/or accesses a local inventory database with product information that can be accessed based on a product identifier, and some or all of that product information may be incorporated into the virtual cart). In some embodiments, the cart generation system can apply a bounding box key point evaluation 1234 (e.g., determines the accuracy of the bounding box and consequential association of an item with a customer). In some embodiments, the generated and/or updated 1236 virtual cart is maintained in a local and/or remote database 1212 or other computer storage.

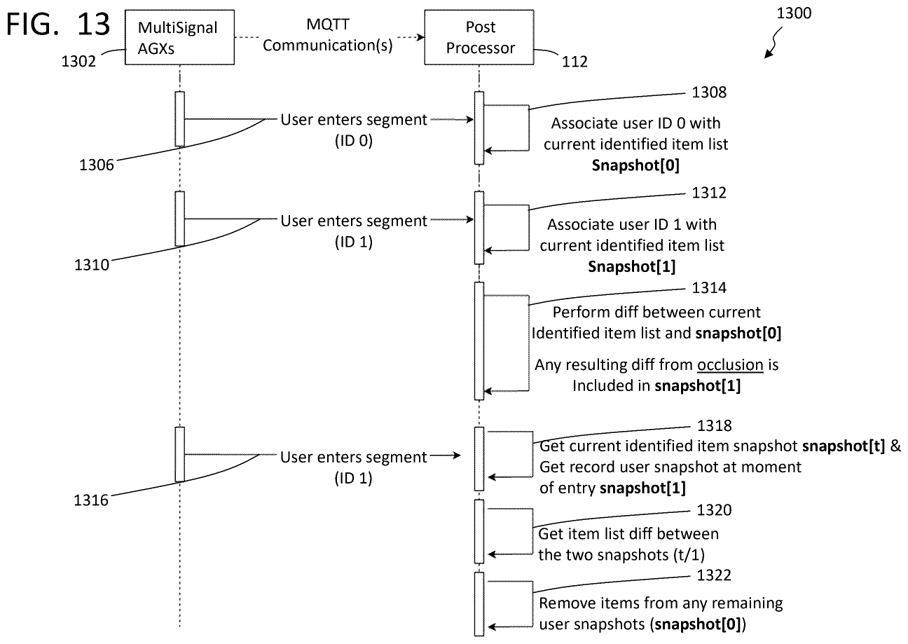

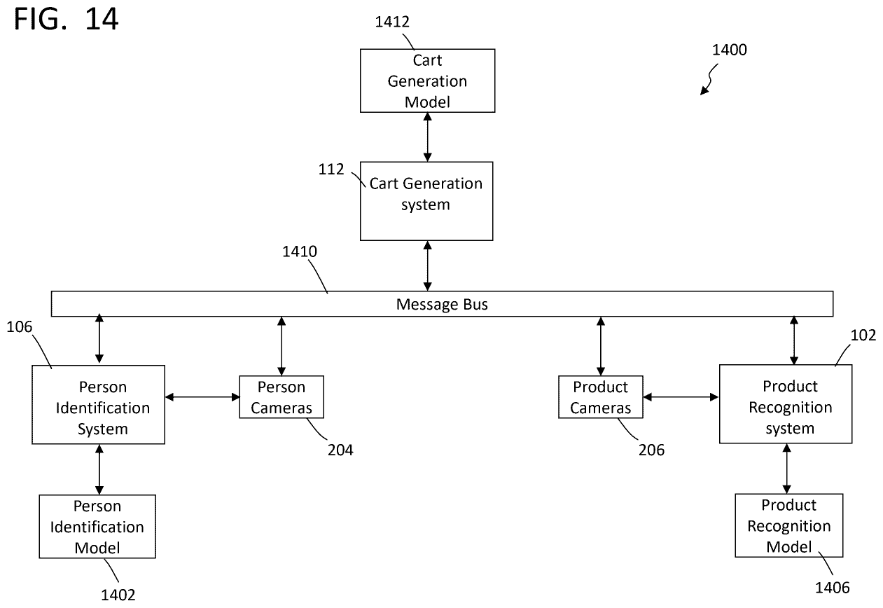

FIG. 13 illustrates an example architectural diagram of an example virtual cart assembly process 1300 implemented as a portion of an example product identification and allocation system 100, in accordance with some embodiments. A person can be uniquely identified as the person moves into a zone 201 and/or subsection of a zone. Some embodiments capture, through the first set of cameras 202, a cumulative listing or snapshot (e.g., determined UPCs and/or coordinates) of the products within the zone 201 or segment of a zone. This listing of products can be initially associated with a generated uniquely identified of the person. In some embodiments, when a user leaves the zone or segment, a subsequent current cumulative listing or snapshot is obtained of the products within the zone or segment. The initial snapshot and subsequent snapshot can be compared. a difference in products between the initial or entry snapshot and the exit snapshot is evaluated and use to generate a zone virtual cart and/or updated zone virtual cart corresponding to the person identifier corresponding to the zone. The architecture diagram 1300 can include communications from one or more processing systems 1302 (which may include one or more product identification systems 102 and/or one or more person identification systems 106) which may be in MQTT communication with a cart generation system 112. The cart generation system 112 associated with a zone 201 can receive 1306 a notification when a person enters a zone 201 (or segment of a zone) and a unique person identifier associated with person (e.g., user ID 0). The cart generation system 112 can associate the initial user ID 0 with an entry or initial current identified product list 1308 of products within the zone (or segment) at that time (e.g., snapshot[0]). The virtual cart generation system 112 may subsequently receive 1310 one or more subsequent notice 1310 as the person moves through a zone (e.g., enters another segment), and the person is associated with a corresponding person identifier (e.g., user ID 1). The virtual cart generation system 112 can associate 1312 the user ID 1 with a current identified product list of products within the zone or segment (e.g., snapshot[1]). The cart generation system can further determine a difference 1314 between the current identified product list (snapshot[1]) and the initial product listing (snapshot[0]), and accounts for any differences related to occlusion in snapshot[1] 1314. One or more subsequent notifications 1310 can continue to be received as the person moves through the segment of the zone with repeated differences. The virtual cart generation system can receive an exit notification 1316 when the person exits the segment or zone (e.g., user ID 1). The cart generation system can again obtain a current product list 1318 for the zone (e.g., snapshot[t]) of identified products and the entry snapshot (snapshot[1]). The virtual cart generation system can further determine a difference in the product lists between the snapshot[t] and the snapshot[1] (e.g., t/1) 1320, and in some embodiments can remove identified products from the initial product list (e.g., snapshot[0]). Some embodiments may clear a snapshot record and/or remove 1322 items from remaining user snapshots (snapshot[0]).

FIG. 14 shows an example virtual cart architecture diagram 1400 in accordance with some embodiments. The architecture diagram 1400 may be implemented through the product identification and allocation system 100 or one or more components thereof. In some embodiments, the architecture diagram 1400 includes one or more person recognition systems 106, one or more product identification systems 102, and one or more cart generation systems 112. The person recognition system 106, in some embodiments, can implement and/or execute one or more machine learning person recognition models 1402. The product identification system 102 can, in some embodiments, implement one or more machine learning product identification models 1406. The cart generation system 112 can, in some embodiments, implement one or more machine learning cart generation models 1412. The person recognition model 1402 can be supplied with image data of and/or images captured by one or more of the first set of cameras 204 and the product identification model 1406 can be supplied with image data of images captured by one or more of the second set of cameras 206. The cart generation system 112 can access data from the person recognition system and/or the product identification system, and/or person recognition system 106, the product identification system 102, the first set of cameras 204 and/or the second set of cameras 206 may be communicatively coupled with the cart generation system 112 via one or more of the communication networks 108 (e.g., a message bus 1410).

In some embodiments, images captured by the first set of person cameras 204 and/or image data of images captured by the first set of cameras 204 can be processed by the person recognition model 1402 in generating one or more unique person identifiers of a person within a respective zone. The person identifier may comprise one or more vectors, be based on one or more vectors, or other such known methods of generating identifiers based on physical characteristics of a person. The product identification model 1406 can be supplied images and/or image data captured by the second set of product cameras 206, and identify one or more products that have been removed from a product support system. The cart generation model 1412, in some embodiments, can process the person information and retrieved product information and associate identified products with identified people having a threshold correlation with a respective removed product. The cart generation model 1412 can receive information regarding identified objects and people, and generates one or more virtual zone carts that are associated with a respective single unique person identifier and a corresponding zone as people move through the facility, and allocates products intended for purchase by a person to a corresponding virtual zone cart.

In some embodiments, the person recognition model(s) can be executed on the person recognition system, while in other embodiments, some or all of the person recognition model 1402 may be executed on a remote system accessible to the person recognition system 106 through the one or more communication networks 108. In some embodiments, the product identification model(s) can be executed on the product identification system, while in other embodiments, some or all of the product identification model 1406 may be executed on a remote system accessible to the person recognition system 106 through the one or more communication networks 108. In some embodiments, the cart generation model(s) can be executed on the cart generation system, while in other embodiments, some or all of the cart generation model 1412 may be executed on a remote system accessible to the person recognition system 106 through the one or more communication networks 108.

The above and below described machine learning models, as described, are trained and retained over time using respective sets of relevant data, images, feedback and/or other such relevant data. The data can be used to train and retrain the different machine learning models, in some embodiments, through one or more model training systems and/or servers. These training systems and/or servers can be implemented by the retail facility, a retail company, a third party service or other entity. The trained models can be maintained in one or more databases and some or all of these models can be distributed to and/or implemented by the product identification systems 102, person identification systems 106, cart generation systems 112, cumulative virtual cart generation systems 120, checkout person identification systems 130, zone allocation systems 126, purchase control systems 128, and/or other systems of the product identification and allocation system 100. The models distributed can, in some embodiments, be dependent on expected products to be identified, locations within the retail facility to be evaluated, corresponding zone, the information and/or data to be evaluated, other such factors, or a combination of two or more of such factors. The above and below machine learning models can be implemented through one or more types of machine learning models and/or machine learning algorithms such as, but are not limited to, deep learning models, neural network models, deep stacking networks (DSN), Tensor deep stacking networks, convolutional neural network, probabilistic neural network, autoencoder or Diabolo network, linear regression, support vector machine, Naive Bayes, logistic regression, K-Nearest Neighbors (kNN), decision trees, random forest, gradient boosted decision trees (GBDT), K-Means Clustering, hierarchical clustering, DBSCAN clustering, principal component analysis (PCA), and/or other such models, networks and/or algorithms. Further, in some applications one or more of the modeling techniques may apply one or more filters and other such processing. In some embodiments, for example, the modeling can apply a series or sequence of multiple filters to narrow the potential product with which the product in an image potentially corresponds. Filtering and/or successive filtering can narrow the pool of potential products. The filtering can for example, include shape filtering, color filtering, boarder and/or boundary filtering, other such filtering, and typically a combination of two or more of such filtering. One or more of the models may be implemented through modelings that are available through third party sources and/or vendors, such as but not limited to NVIDIA Corporation, MobileNetV2, and/or other sources.

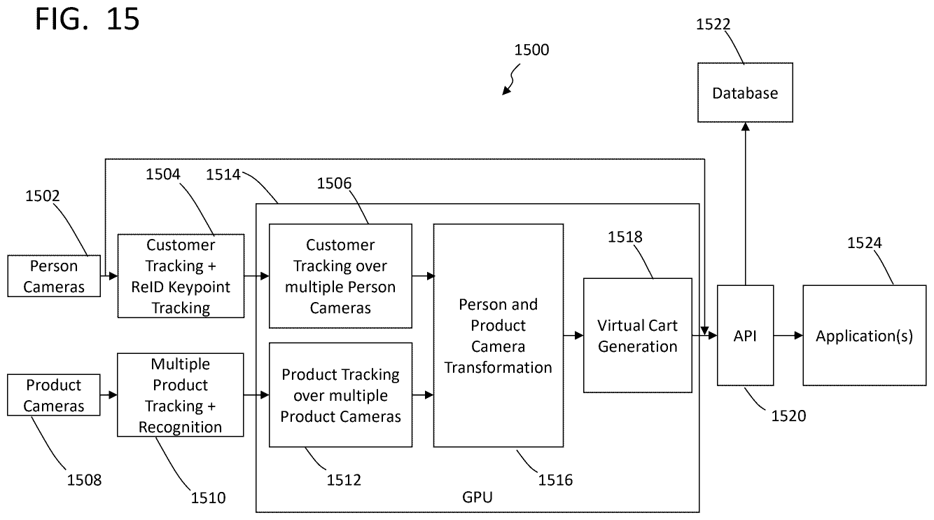

FIG. 15 shows a block diagram of an example virtual cart generation system 1500 in accordance with some embodiments. The cart generation system 1500 may implement some or all be the product identification and allocation system 100 or components thereof. The cart generation system 1500 can include person cameras 1502 (e.g., the cameras 204, 1404) and product cameras 1508 (e.g., the cameras 206, 1408). The person cameras 1502 are coupled to a customer tracking and ReID key point tracking component 1504 and the product cameras 1508 are coupled to a multiple product tracking and recognition component 1510. The system 1500 further includes a graphics processing unit (GPU) 1514 including a component for customer tracking over multiple person cameras 1506, a component for product tracking over multiple product cameras 1512, a person and product camera transformation component 1516, and a retail cart generation component 1518 (e.g., the cart generation system 112 or the cart generation model 1412). The customer tracking and ReID key point tracking component 1504 is coupled with the component for customer tracking over multiple person cameras 1506 of the GPU 1514 and the multiple product tracking and recognition component 1510 is coupled with the component for product tracking over multiple product cameras 1512 of the GPU 1514.

In some embodiments, the person cameras 1502, the customer tracking and ReID key point tracking component 1504, and the component for customer tracking over multiple person cameras 1506 are components of the person identification system 106 and are configured to perform aspects of the person identification system 106 described herein. In some embodiments, the product cameras 1508, the multiple product tracking and recognition component 1510, and the component for product tracking over multiple product cameras 1512 are components of the product identification system 102 and are configured to perform aspects of the product identification system 102 described herein. The component for customer tracking over multiple person cameras 1506 and the component for product tracking over multiple product cameras 1512 are further coupled to the person and product camera transformation component 1516. The person and product camera transformation component 1516 is further coupled to the retail cart generation component 1518. The retail cart generation component 1518 is further coupled to an application programming interface (API) 1520. The API 1520 receives images from the person cameras 1502 and a generated retail cart from the retail cart generation component 1518, and outputs the information to at least a database 1522 and an application 1524.

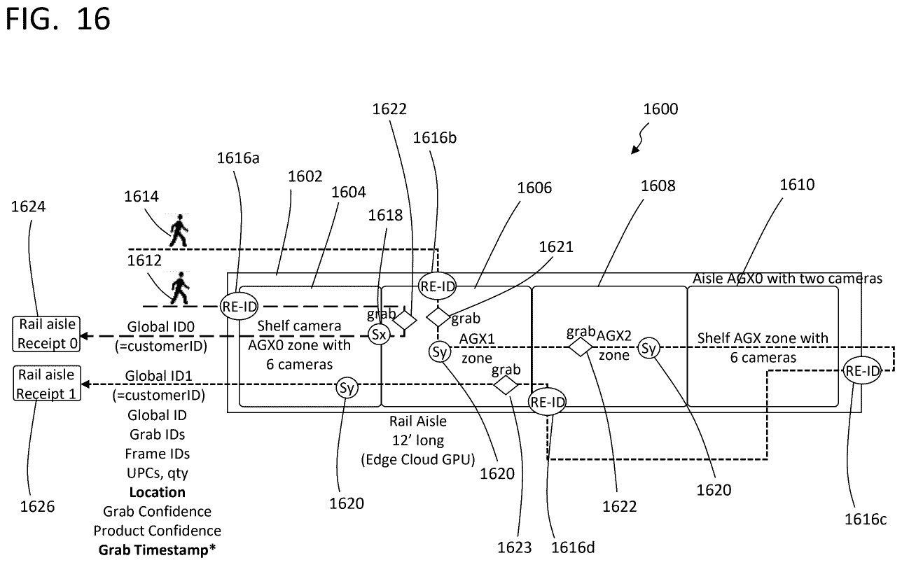

FIG. 16 shows a block diagram of an example process of virtual zone cart generation 1600 in accordance with some embodiments, implemented through the product identification and allocation system 100. The process 1600 depicts a first person 1612 and a second person 1614 relative to an aisle 1602 (AGX0) with two or more person cameras of the first set of cameras 206 (not illustrated), with four zones 1604, 1608, 1610 shown. Each zone can include two or more shelf cameras of the second sets of cameras 206. The first person 1612 follows a first path. Upon the first person 1612 entering the first zone 1604, a person identifier can be generated, and in some instances may be re-identified when a generated identifier has a threshold relationship with an earlier generated identifier. In some implementations, a person is identified (IDed) 1616a upon entry a firs zone, a facility or other initial identification, and may be subsequently re-identified (Re-ID) as the person moves through the facility based on a threshold correlation between two or more generated identifiers.

A product identification system of the zone 1610 can detect 1622 that a product is retrieved by the first person 1612 in the second zone 1606, and a cart generation system 112 can associate 1618 within a virtual zone cart (Sx) 1618 the retrieved product with and the first person identifier. In some embodiments, the virtual first zone and person identifier 1616a of the first person 1612 can be associated 1625 with a global ID and a zone receipt 1624 or rail aisle receipt may be generated in response to the first person 1612 exiting the zone 1610, moving a threshold distance from the zone and/or upon the first person approaching or entering an exit zone of the facility that is associated with a completion of a shopping experience. Similarly, a person identifier 1616b (or re-identifier) can be generated in response to the second person 1614 entering the aisle 1602 and/or second zone 1606. A product identification system 102 associated with the second zone 1606 can detect 1621 that the second person 1614 retrieved one or more products, and in some embodiments a cart generation system can associate the one or more retrieved products with a zone virtual cart (Sy) 1620 corresponding to the second person identifier. The second person 1614 can be tracked by one or more zone person identification systems (e.g., zone product identification system of the third zone 1608) as the second person moves to the third zone 1608. A zone product identification system can detect 1622 that one or more products have been removed from a product support system, and a corresponding zone cart generation system can associate the one or more products with the virtual cart (Sy) 1620 that continues to be associated with the tracked second person 1614, or a separate virtual zone cart. In some embodiments, the second person 1614 may be re-identified 1616c as the person moves back into the fourth zone and the third zone 1616d after having exited and/or no longer continuously tracked.

In some embodiments, one or more products may be detected as retrieved 1623 and incorporated into a zone virtual cart and/or associated with a previous virtual zone cart when a threshold relationship between person identifiers is determined. For example, the second person 1614 may re-enter the aisle 1602 and be re-identified (Re-ID) 1616 upon entry and further re-entering the third zone 1610. The second person 1614 can proceed to exit the fourth zone 1610 and the aisle 1602, and then detected to have re-entered the third zone 1608 and can be re-identified 1616. The second person 1614 can be tracked as the second person moves to the second zone 1606 and grabs 1622 an additional item, which can be associated 1620 with a virtual zone cart or a previous virtual zone cart 1620 (e.g., when the person identifier has a threshold relationship with a previously generated person identifier). The second person 1614 proceeds to exit the first zone 1604 and aisle 1602. In some embodiments, the second person 1614 can be associated with a global identifier (e.g., based on a determined threshold relationship between two or more person identifiers), and respective one or more zone virtual carts can be associated with the global identifier.

Further, in some embodiment a zone and/or aisle receipt 1626 can be generated corresponding to the one or more zone virtual carts associated with the global identifier. In some embodiments, each person is identified and/or re-identified upon entering a zone and/or area (e.g., an aisle), tracked as the person moves through the zone and/or two or more zones, and products retrieved can be associated with the person identifier associated with the person, such as in response to determining a threshold relationship between the person and the removed one or more products (e.g., a threshold distance, a person's path through a zone, a lack of another person being within a threshold distance of a removed product within a threshold period of time, and/or other such detected relationships). Products can be further associated with an aggregate of products retrieved across multiple zones and associated with the person. The zone and/or aisle receipts 1624, 1626 may include and/or be associated with a global ID, product identifiers (grab IDs), Frame IDs (e.g., identifiers of an image), product identifying information (e.g., universal product codes (UPC)), product quantity, a retrieval or grab confidence, product identification confidence, grab timestamp, etc., relative to a specific person and one or more zones. In some embodiments a person is reidentified 1616 each time the person re-enters an aisle 1602 or other set of continuous zones, and the identifier is associated further with products grabbed by the person. Further, in some embodiments the person may be associated with a single identifier each time they enter an aisle (e.g., in response to determining a threshold relationship between the single identifier and one or more subsequently generated person identifier(s), and the identifiers are unique from person to person.

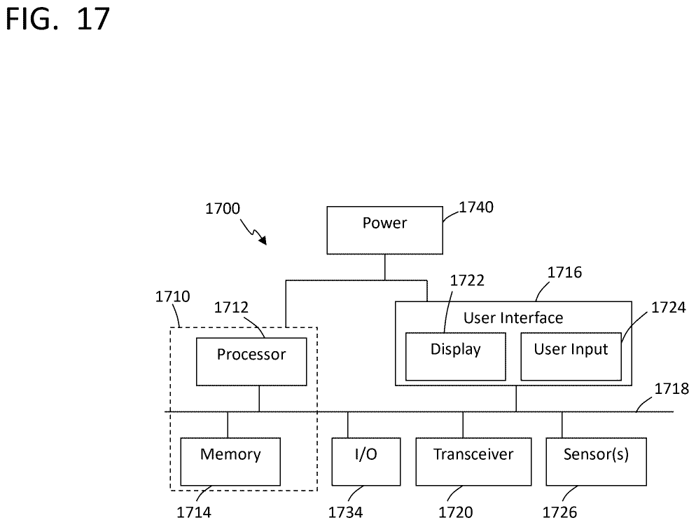

Further, the circuits, circuitry, systems, devices, processes, methods, techniques, functionality, services, servers, sources and the like described herein may be utilized, implemented and/or run on many different types of devices and/or systems. FIG. 17 illustrates an example system 1700 that may be used for implementing some or all of the components, circuits, circuitry, systems, functionality, apparatuses, processes, or devices of the product identification and allocation system 100 of FIG. 1, and/or other above or below mentioned systems or devices, or parts of such circuits, circuitry, functionality, systems, apparatuses, processes, or devices. For example, the system 1700 may be used to implement some or all of the one or more product identification systems 102, the one or more person identification systems 106, the one or more camera systems 110, the one or more cart generation systems 112, the one or more inventory systems 116, central control circuit, a product identification control circuit, a person identification control circuit, a cart generation control circuit, a camera control circuit, an inventory control circuit, user computing systems 114, and/or other such components, circuitry, functionality and/or devices. However, the use of the system 1700 or any portion thereof is certainly not required.

By way of example, the system 1700 may comprise one or more control circuits or processor modules 1712, one or more memory 1714, and one or more communication links, paths, buses or the like 1718. Some embodiments may include one or more user interfaces 1716, and/or one or more internal and/or external power sources or supplies 1740. The control circuit 1712 can be implemented through one or more processors, microprocessors, central processing unit, logic, local digital storage, firmware, software, and/or other control hardware and/or software, and may be used to execute or assist in executing the steps of the processes, methods, functionality and techniques described herein, and control various communications, decisions, programs, content, listings, services, interfaces, logging, reporting, etc. Further, in some embodiments, the control circuit 1712 can be part of control circuitry and/or a control system 1710, which may be implemented through one or more processors with access to one or more memory 1714 that can store instructions, code and the like that is implemented by the control circuit and/or processors 1712 to implement intended functionality. In some applications, the control circuit and/or memory may be distributed over a communications network (e.g., LAN, WAN, Internet) providing distributed and/or redundant processing and functionality. Again, the system 1700 may be used to implement one or more of the above or below, or parts of, components, circuits, systems, processes and the like. For example, the system may implement the one or more product identification systems 102 with the control circuit being a product identification control circuit, the one or more person identification systems 106 with the control circuit being a person identification control circuit, the one or more camera systems 110 with the control circuit being a camera control circuit, the one or more cart generation systems 112 with the control circuit being a cart generation control circuit, the inventory system 116 with an inventory system control circuit, or other components.

The user interface 1716 can allow a user to interact with the system 1700 and receive information through the system. In some instances, the user interface 1716 includes a display 1722 and/or one or more user inputs 1724, such as buttons, touch screen, track ball, keyboard, mouse, etc., which can be part of or wired or wirelessly coupled with the system 1700. Typically, the system 1700 further includes one or more communication interfaces, ports, transceivers 1720 and the like allowing the system 1700 to communicate over a communication bus, a distributed computer and/or communication network 108 (e.g., a local area network (LAN), the Internet, wide area network (WAN), etc.), communication link 1718, other networks or communication channels with other devices and/or other such communications or combination of two or more of such communication methods. Further the transceiver 1720 can be configured for wired, wireless, optical, fiber optical cable, satellite, or other such communication configurations or combinations of two or more of such communications. Some embodiments include one or more input/output (I/O) ports 1734 that allow one or more devices to couple with the system 1700. The I/O ports can be substantially any relevant port or combinations of ports, such as but not limited to USB, Ethernet, or other such ports. The I/O interface 1734 can be configured to allow wired and/or wireless communication coupling to external components. For example, the I/O interface can provide wired communication and/or wireless communication (e.g., Wi-Fi, Bluetooth, cellular, RF, and/or other such wireless communication), and in some instances may include any known wired and/or wireless interfacing device, circuit and/or connecting device, such as but not limited to one or more transmitters, receivers, transceivers, or combination of two or more of such devices.

In some embodiments, the system may include one or more sensors 1726 to provide information to the system and/or sensor information that is communicated to another component. The sensors can include substantially any relevant sensor, such as distance measurement sensors (e.g., optical units, sound/ultrasound units, etc.), optical-based scanning sensors to sense and read optical patterns (e.g., bar codes), radio frequency identification (RFID) tag reader sensors capable of reading RFID tags in proximity to the sensor, and other such sensors. The foregoing examples are intended to be illustrative and are not intended to convey an exhaustive listing of all possible sensors. Instead, it will be understood that these teachings will accommodate sensing any of a wide variety of circumstances in a given application setting.

The system 1700 comprises an example of a control and/or processor-based system with the control circuit 1712. Again, the control circuit 1712 can be implemented through one or more processors, controllers, central processing units, logic, software and the like. Further, in some implementations the control circuit 1712 may provide multiprocessor functionality.

The memory 1714, which can be accessed by the control circuit 1712, typically includes one or more processor-readable and/or computer-readable media accessed by at least the control circuit 1712, and can include volatile and/or nonvolatile media, such as RAM, ROM, EEPROM, flash memory and/or other memory technology. Further, the memory 1714 is shown as internal to the control system 1710; however, the memory 1714 can be internal, external or a combination of internal and external memory. Similarly, some or all of the memory 1714 can be internal, external or a combination of internal and external memory of the control circuit 1712. The external memory can be substantially any relevant memory such as, but not limited to, solid-state storage devices or drives, hard drive, one or more of universal serial bus (USB) stick or drive, flash memory secure digital (SD) card, other memory cards, and other such memory or combinations of two or more of such memory, and some or all of the memory may be distributed at multiple locations over the computer network 108. The memory 1714 can store code, software, executables, scripts, data, content, lists, programming, programs, log or history data, user information, customer information, product information, and the like. While FIG. 17 illustrates the various components being coupled together via a bus, it is understood that the various components may actually be coupled to the control circuit and/or one or more other components directly.

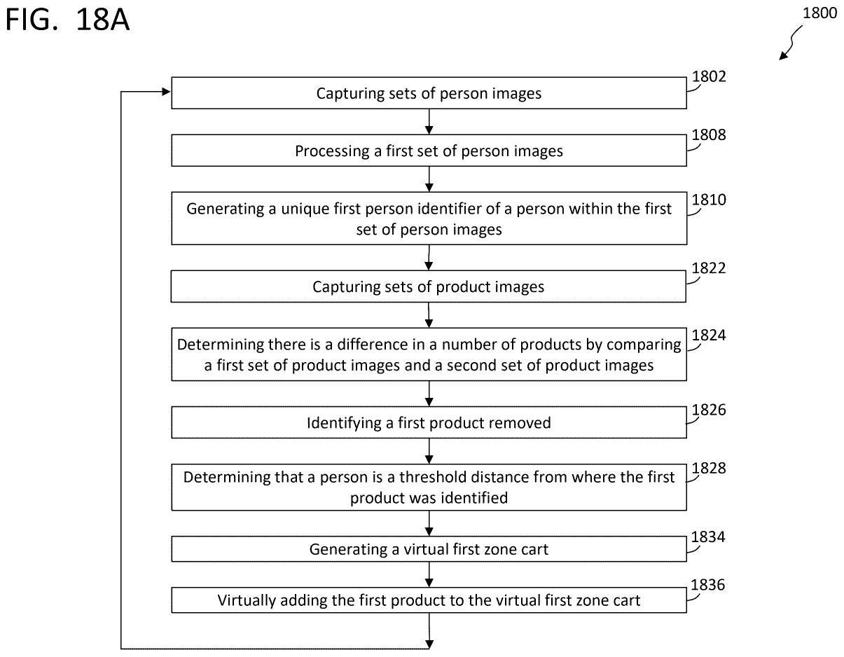

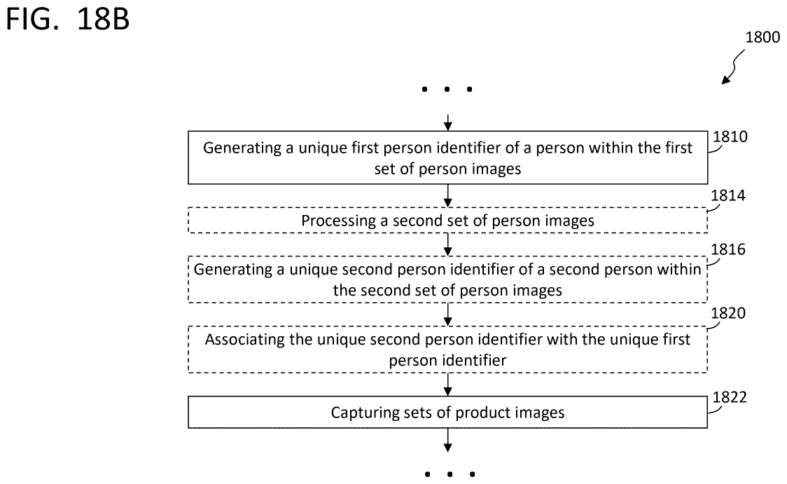

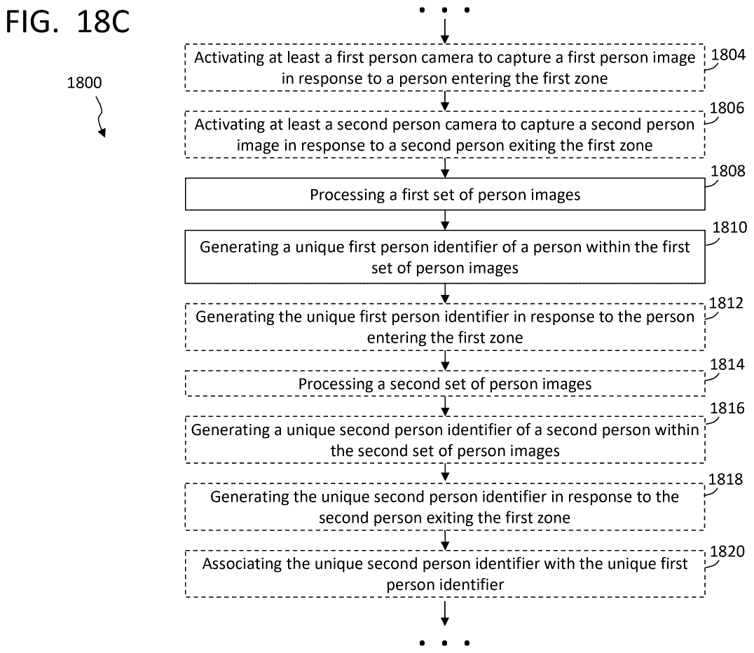

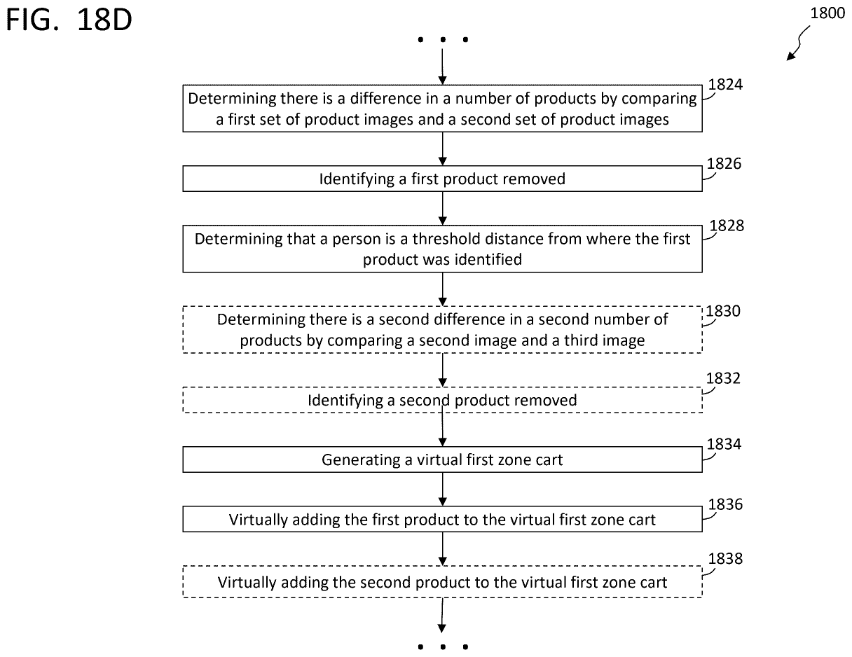

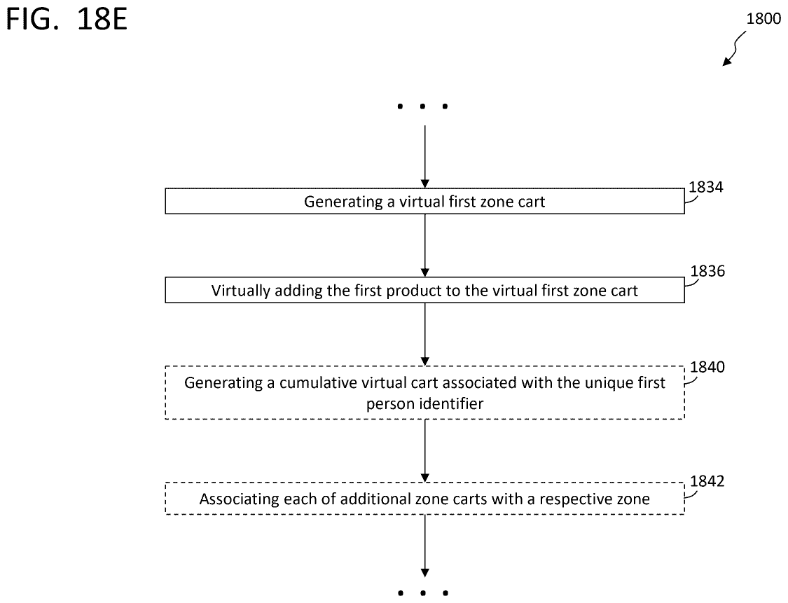

FIGS. 18A-18E illustrate a flow diagram of an example process 1800 of product identification and allocation within a retail facility, in accordance with some embodiments. Generally, the process 1800 is used in an identification and allocation system, such as the product identification and allocation system 100, and may utilize components of the product identification and allocation system 100 and the product identification and allocation subsystems 200, 500, 600, 900, 1000.

Now referring to FIG. 18A, in step 1802, the product identification and allocation system captures sets of person images by a first set of cameras each positioned at a different one of first predefined location corresponding to a first zone of multiple different zones throughout a retail facility. The sets of person images may be of a person at the first zone. In some embodiments, as shown in FIG. 18C, the process 1800 further includes step 1804, where at least a first camera, of the first set of cameras, is activated to capture a first person image of a first set of person images. The activation of the first camera can be in response to detecting the person entering the first zone. In some embodiments, as shown in FIG. 18C, the process 1800 further includes step 1806, where at least a second camera, of the first set of cameras, is activated to capture a second person image of a second set of person images. The activation of the second person camera can be in response to detecting the person exiting the first zone.

In step 1808, a person identification control circuit processes the first set of person images of the sets of person images. In step 1810, a person identification control circuit generates a unique first person identifier of the person captured within the first set of person images based at least on the first set of person images of the person at the first zone. In some embodiments, generating the first person identifier may include generating a vector based on characteristics, within the first set of person images, of the person captured within the first set of person images. In some embodiments, the processing of the first set of person images and generating the first person identifier may be done locally at the first zone by the person identification control circuit and may further include communicating the first person identifier over a local network. In some embodiments, as shown in FIG. 18C, the process 1800 further includes step 1812, where the unique first person identifier is generated in response to the person entering the first zone.

In some embodiments, as shown in FIG. 18B, the process 1800 includes step 1814, where the second set of person images capturing a second person at the first zone is processed. In some embodiments, the process 1800 includes step 1816, where a unique second person identifier of the second person captured within the second set of person images is generated. In some embodiments, the process 1800 further includes step 1818, where the unique second person identifier is generated in response to the second person exiting the first zone. In some embodiments, as shown in FIG. 18B, the process 1800 includes step 1820, where the unique second person identifier is associated with the first person identifier when the unique second person identifier is within an identifier threshold difference of the first person identifier indicating that the person and the second person are estimated to be the same person. In some embodiments, person identification control circuit can perform the above steps 1814, 1816, 1818, 1820.

In step, 1822, sets of product images are captured by a second set of cameras each positioned at a different one of second predefined locations in the first zone. The sets of product images may include products within the first zone that are available for purchase by customers of the retail facility. In some embodiments, one or more of the cameras of the second set of cameras are spaced such that a first field of view of a first camera of the second set of cameras overlaps with a second field of view of an adjacent second product camera of the second set of cameras. In some embodiments, capturing the sets of product images includes capturing the first set of product images of a first set of products positioned on a second side of an aisle by a first camera of the second set of cameras positioned on a first side of the aisle, and capturing a third set of product images of a second set of products positioned on the first side of the aisle by a second camera of the second set of cameras positioned on the second side of the aisle. The aisle may be within the first zone, and the first camera may be oriented with a first field of view directed to the second side of the aisle opposite the first side of the aisle and the second camera may be oriented with a second field of view directed to the first side of the aisle.

In step 1824, a product identification control circuit determines there is a difference in a number of products within the first zone by comparing a first set of product images with a second set of product images. The first set of product images can be captured before a threshold first period time has elapsed, and the second set of product images can be captured after the threshold first period of time has elapsed. In step 1826, a product identification control circuit identifies a first product removed based on the determined difference in the number of products within the first zone. Identifying the first product has been removed may include identifying, from the first image captured by the first camera of the second set of cameras having a first field of view overlapping a second field of view of the adjacent second camera of the second set of cameras, that the first product is removed, and identifying based on a second image captured by the second camera that the first product is removed. Some embodiments include step 1828, where it can be determined that the person is at least a threshold first distance from a portion of shelves where the first product was identified, at or after the threshold first period of time.

In some embodiments, as shown in FIG. 18D, the process 1800 further includes the step 1830, where it can be determined there is a second difference in a second number of a second set of products within the first zone by comparing a second image and a third image. The second image can be captured at a second time, and the third image can be captured a threshold second period of time after the second person has moved a threshold second distance from the second set of products. In some embodiments, the process 1800 further includes step 1832, where a product identification control circuit identifies a second product, of the second set of products, removed based on the determined second difference in the second number of the second set of products within the first zone.

In step 1834, a first virtual zone cart can be generated and associated with the first person identifier of the first zone. The generating the virtual first zone cart may include accessing, via a distributed network, the first person identifier, and associating the virtual first zone cart with the first person identifier. In step 1836, a cart generation control circuit virtually adds the first product identified to the virtual first zone cart associated with the first person identifier. Identifying the first product may include preventing the first product from being added twice to the virtual first zone cart based on the overlap of the first field of view of the first camera and the second field of view of the second camera described above.

In some embodiments, as shown in FIG. 18D, the process 1800 can further include the step 1838, where the second product identified can be virtually added to the virtual first zone cart associated with the first person identifier and the first zone. The second product can be added to the first zone virtual cart after the identification that the second product is removed and the identification that the second person identifier is within the identifier threshold difference of the first person identifier.

In some embodiments, as shown in FIG. 18E, the process 1800 includes step 1840, where a cumulative virtual cart can be generated that is exclusively associated with the first person identifier. The cumulative virtual cart may be generated by combining the virtual first zone cart associated with the first person identifier with one or more additional virtual zone carts each exclusively associated with a respective one of additional person identifiers each within a threshold difference of the first person identifier. In some embodiments, the process 1800 further includes step 1842, where each of the one or more additional virtual zone carts can be associated with a different respective zone of the multiple different zones within the retail facility.

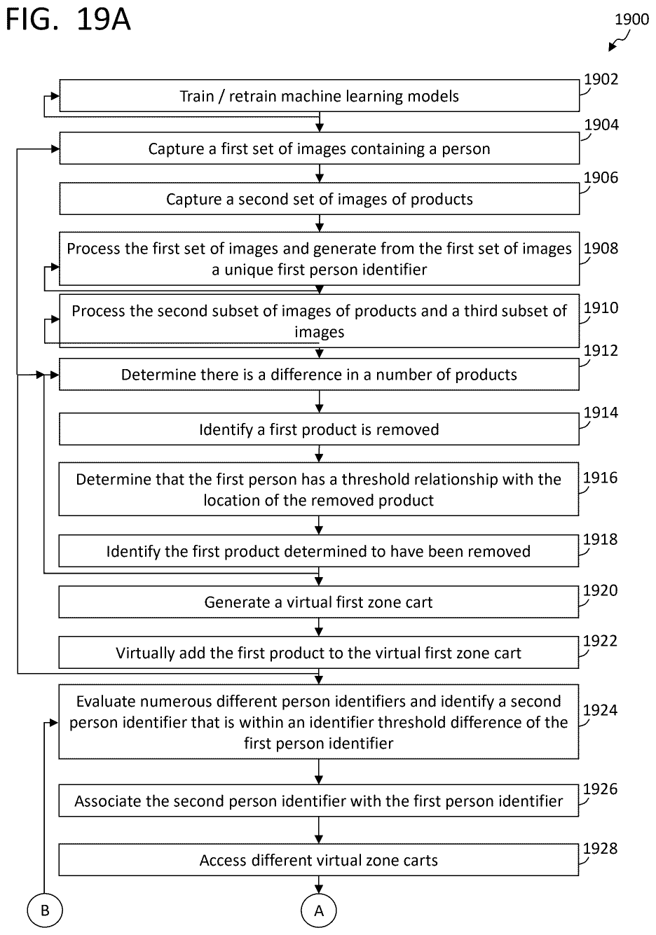

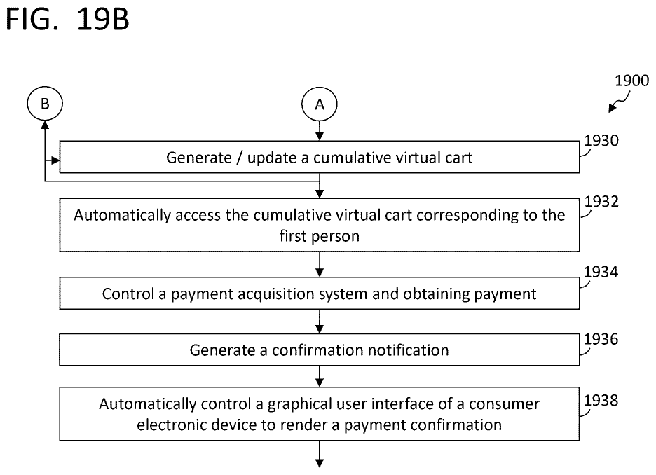

FIGS. 19A-19B illustrates a flow diagram of an example process 1900 of controlling a retail facility in accordance with a segmentation into zones and control purchase systems to automate product allocation and purchase, in accordance with some embodiments. Some embodiments include step 1902 where one or more machine learning models are trained and retrained over time according to specific historic data, inventory data, customer data, other such data or a combination of two or more of such data. For example, some embodiments train each of multiple different zone product identification machine learning models that are each associated with a different one of the multiple zones 201. The training can be based on a restricted corpus of product information restricted to information corresponding to a restricted set of potential products expected to be positioned within the respective one of the zones 201. Further, the zone product identification models can be retrained over time based on feedback, such as feedback from identification of products by the first zone product identification machine learning model, subsequent customer actions, subsequent purchases, subsequent removal of items from a virtual cart, updated product information of products expected to be placed in the respective zone, other such data, or a combination of two or more of such data.

In step 1904, sets of person images can be captured by the first set of cameras 204 that are each positioned at a different one of first predefined locations corresponding to a first zone 201. In step 1906, a second set of images of products within the first zone and available for purchase can be captured by the second set of cameras 206 of the first zone 201 that are each positioned at a different one of second predefined locations in the first zone. In step 1908, a first set of images, of the sets of person images captured by one or more of the first set of cameras 204 of the first zone of the multiple zones distributed throughout the retail facility while a person is at the first zone, can be processed by a control circuit 101 executing person identification code set 136, and a unique first person identifier can be generated from the first set of images of the first person captured within the first set of images.

In step 1910, a second subset of images of the product images capturing product within a zone are processed relative to a third subset of images of the product images. In step 1912, it is determined based on the processing of the product images that there is a difference in a number of products within the first zone 201 by comparing the second subset of images captured before a threshold first period of time has elapsed, and the third subset of images captured after the threshold first period of time has elapsed. In step 1914, a first product can be identified that is determined to have been removed based on the determined difference in the sets of products and/or number of products within the first zone. In some embodiments, in determining that the first product has been removed from the product support system 212, can identify that the first product has been removed from the product support system based on a difference between the first subset of one or more images of the second set of images and the second subset of one or more images of the second set of images.

In step 1616, it can be determined, by a product identification system 102 at or after the threshold first period of time, that the first person is at least a threshold distance from a portion of the product support system 212 where the first product was removed. In step 1618, some embodiments identify, based on a first set of products within the first zone and available to be retrieved and purchased by customers and supported by the product support system 212, that the first product, of the first set of products, is determined to have been removed from the product support system by the first person. In some embodiments, a person identification system 106, product identification system 102, a respective control circuit 101 and memory, and a zone cart generation system 112 can be positioned locally at the first zone within the retail facility and can be communicatively coupled via one or more local networks. The identification of the first product can be achieved through the initiation of a locally implemented zone product identification machine learning model to identify the first product, of the first set of products, that is determined to have been removed from the product support system by the first person.

In step 1920, a virtual first zone cart is generated that is associated with the first person identifier and the first zone. In step 1922, the first product is virtually added to the virtual first zone cart associated with the first person identifier. In some embodiments, the cart generation system 112, in virtually adding the first product to the virtual first zone cart, can virtually add the first product to the virtual first zone cart in response to the identification of the removal of the first product, determined to have been removed from the product support system and the association of the first customer with the first product. Some embodiments step 1924 can be implemented where numerous different person identifiers can be evaluated to identify a second person identifier, of multiple additional person identifiers, that is within an identifier threshold difference of the first person identifier indicating an estimation that the first person identifier and the second person identifier were generated based on the first person at different locations within the retail facility. This second person identifier may be generated by the same person identifier system 106 in a single zone, or a different person identifier system 106 of a different zone. In step 1926, the second person identifier can be associated with the first person identifier when the second person identifier is within the identifier threshold difference of the first person identifier. The evaluation in step 1924 and association in step 1926 can be repeated any number of times while a person is in the same zone and/or moving through two or more zones of the retail facility.

In step 1928, a cumulative virtual cart generation system 120, which may be implemented through one or more cumulative virtual cart generation control circuit 143 executing a cumulative virtual cart generation code set 144, can access different virtual zone carts generated by different zone cart generation systems implemented through one or more zone cart generation control circuits executing respective zone cart generation code sets. In step 1930, a cumulative virtual cart can be generated, exclusively associated with the first person identifier, combining the virtual first zone cart, associated with the first person identifier, with one or more additional virtual zone carts each exclusively associated with a respective one of additional person identifiers, generated corresponding to a different one of the multiple zones, and each within a threshold difference of the first person identifier. In some embodiments, the virtual first zone cart can be combined with a virtual second zone cart, exclusively associated with the second person identifier and a second zone, into the cumulative virtual cart based on associating the first person identifier with the second person identifier.

In step 1932, the cumulative virtual cart corresponding to the first person can be automatically accessed by a purchase control system 128. In step 1934, the purchase control system can control one or more payment acquisition systems in obtaining payment for each product identified within the cumulative virtual cart. These payment acquisition systems can be credit card systems, cash receiving systems, wireless communication payment systems (e.g., that communicate with smartphones to receive payment information), and/or other such systems. In step 1936, a confirmation notification can be generated. This confirmation can comprise an electronic receipt, a paper receipt, and/or other such confirmation. In some embodiments, the confirmation can include a machine readable code (e.g., barcode, QR code, etc.). Some embodiments include step 1938, wherein the purchase control system 128 can control a transceiver to communicate the confirmation, and automatically control a graphical user interface of a user computing system 114 associated with the first person to render a payment confirmation interface comprising confirmation information, which may be machine readable and/or a portion of the confirmation may be machine readable (e.g., bar code, QR code, etc.).

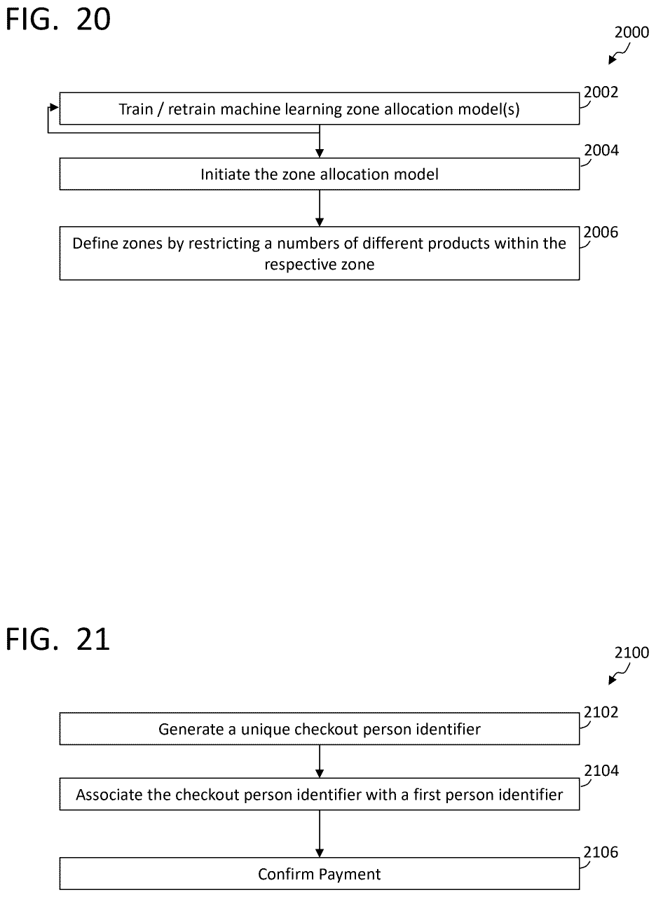

FIG. 20 illustrates a flow diagram of a process 2000 of dividing up and defining multiple zones 201 distributed through a retail facility, in accordance with some embodiments. In step 2002, a zone allocation machine learning model is trained based on a zone corpus of information, and can be retrained over time based in part on feedback of subsequent product identifications within the first zone. In step 2004, the trained zone allocation machine learning model is initiated based on inventory data, product location mapping, the product identifiers, other such data, or a combination of two or more of such data. In step 2006, at least a subset of one or more zones are defined, through a zone allocation control circuit communicatively coupled with an inventory database, by restricting a numbers of different products, each having a different unique product identifier, within the respective zone as a function of densities of product identifiers within different sections of the retail facility. The restriction can be based on a threshold number of different product types, a density of the products, other such factors, or a combination of such factors.

FIG. 21 illustrates a flow diagram of an example process 2100 of controlling a confirmation of payment, in accordance with some embodiments. In step 2102, a checkout person identification control circuit 156 when executing a checkout person identification code set 158 of a checkout zone 330 of the retail facility 300, can generate a unique checkout person identifier of a person proximate to and/or within the checkout zone 330 based on a set of checkout person images. In step 2104, the checkout person identifier can be associated with the first person identifier when the checkout person identifier is within an identifier threshold difference of the first person identifier. In step 2106, payment can be confirmed for each of the products identified within the cumulative virtual cart associated with the first person identifier when the checkout person identifier is within the identifier threshold difference of the first person identifier.

Some embodiments provide systems to enable product purchases at a retail facility comprising: multiple zones distributed throughout a retail facility, wherein each zone comprises: a product support system configured to support a first set of products available to be retrieved and purchased by customers; a control circuit of the first zone comprising a processor; and at least one computer memory storage system communicatively coupled with the control circuit and configured to store: a person identification code set of a first zone and executable by the control circuit to process a first set of images, corresponding to the first zone and captured by one or more of a first set of cameras while a first person is at the first zone, and generate from the first set of images a unique first person identifier of the first person captured within the first set of images; a product identification code set of the first zone and executable by the control circuit to identify a first product, of the first set of products, determined to have been removed from the product support system by the first person; and a zone cart generation code set of the first zone and executable by the control circuit to generate a virtual first zone cart associated with the first person identifier and the first zone, and virtually add the first product to the virtual first zone cart associated with the first person identifier; and a cumulative virtual cart generation control circuit is communicatively coupled to access different virtual zone carts generated through the execution of the respective zone cart generation code set, and configured to generate a cumulative virtual cart, exclusively associated with the first person identifier, combining the virtual first zone cart, associated with the first person identifier, with one or more additional virtual zone carts each exclusively associated with a respective one of additional person identifiers, generated by a different one of different multiple zone cart generation control circuits, each within a threshold difference of the first person identifier.

Some embodiments provide methods automated product purchasing at a retail facility, the method comprising: processing, by a control circuit of a first zone of multiple zones distributed throughout a retail facility and executing a person identification code set, a first set of images captured by one or more of a first set of cameras while a first person is at the first zone, and generating from the first set of images a unique first person identifier of the first person captured within the first set of images; identifying, based on a first set of products within the first zone and available to be retrieved and purchased by customers and supported by a product support system, a first product, of the first set of products, determined to have been removed from the product support system by the first person; generating a virtual first zone cart associated with the first person identifier and the first zone; virtually adding the first product to the virtual first zone cart associated with the first person identifier; accessing, by a cumulative virtual cart generation control circuit, different virtual zone carts generated by different zone cart generation control circuits; and generating a cumulative virtual cart, exclusively associated with the first person identifier, combining the virtual first zone cart, associated with the first person identifier, with one or more additional virtual zone carts each exclusively associated with a respective one of additional person identifiers, generated corresponding to a different one of the multiple zones, and each within a threshold difference of the first person identifier.

Some embodiments provide systems to enable product purchases at a retail facility, the system comprising: multiple zones distributed throughout a retail facility, wherein each zone comprises: a product support system configured to support a first set of products available to be retrieved and purchased by customers; a control circuit of the first zone comprising a processor; and at least one computer memory storage system communicatively coupled with the control circuit and configured to store: a person identification code set of a first zone and executable by the control circuit to process a first set of images, corresponding to the first zone and captured by one or more of a first set of cameras while a first person is at the first zone, and generate from the first set of images a unique first person identifier of the first person captured within the first set of images; a product identification code set of the first zone and executable by the control circuit to identify a first product, of the first set of products, determined to have been removed from the product support system by the first person; and a zone cart generation code set of the first zone and executable by the control circuit to generate a virtual first zone cart associated with the first person identifier and the first zone, and virtually add the first product to the virtual first zone cart associated with the first person identifier; and a cumulative virtual cart generation control circuit is communicatively coupled to access different virtual zone carts generated through the execution of the respective zone cart generation code set, and configured to generate a cumulative virtual cart, exclusively associated with the first person identifier, combining the virtual first zone cart, associated with the first person identifier, with one or more additional virtual zone carts each exclusively associated with a respective one of additional person identifiers, generated by a different one of the different multiple zone cart generation control circuits, each within a threshold difference of the first person identifier.

Some embodiments provide methods of automated product purchasing at a retail facility, the method comprising: processing, by a control circuit of a first zone of multiple zones distributed throughout a retail facility and executing a person identification code set, a first set of images captured by one or more of a first set of cameras while a first person is at the first zone, and generating from the first set of images a unique first person identifier of the first person captured within the first set of images; identifying, based on a first set of products within the first zone and available to be retrieved and purchased by customers and supported by a product support system, a first product, of the first set of products, determined to have been removed from the product support system by the first person; generating a virtual first zone cart associated with the first person identifier and the first zone; virtually adding the first product to the virtual first zone cart associated with the first person identifier; accessing, by a cumulative virtual cart generation control circuit, different virtual zone carts generated by different zone cart generation control circuits; and generating a cumulative virtual cart, exclusively associated with the first person identifier, combining the virtual first zone cart, associated with the first person identifier, with one or more additional virtual zone carts each exclusively associated with a respective one of additional person identifiers, generated corresponding to a different one of the multiple zones, and each within a threshold difference of the first person identifier.

Some embodiments provide systems for product identification and allocation within a retail facility, the system comprising: a first set of cameras each positioned at a different one of first predefined locations corresponding to a first zone, of multiple different zones throughout a retail facility, wherein the first set of cameras is configured to capture sets of person images of a person proximate the first zone; a second set of cameras each positioned at a different one of second predefined locations in the first zone, wherein the second set of cameras is configured to capture sets of product images of products within the first zone and available for purchase by customers; a person identification control circuit configured to process a first set of person images, of the sets of person images, and generate a unique first person identifier of the person captured within the first set of person images based on at least the first set of person images of the person at the first zone; a product identification control circuit configured to: determine there is a difference in a number of products within the first zone by comparing a first set of product images before a threshold first period of time has elapsed and a second set of product images after the threshold first period of time has elapsed; identify a first product removed based on the determined difference in the number of products within the first zone; and determine that a person is at least a threshold first distance from a portion of shelves where the first product was identified, at or after the threshold first period of time; and a cart generation control circuit configured to: generate a virtual first zone cart associated with the first person identifier and the first zone; and virtually add the first product to the virtual first zone cart associated with the first person identifier.

Some embodiments provide methods of product identification and allocation within a retail facility, the method comprising: capturing, by a first set of cameras each positioned at a different one of first predefined locations corresponding to a first zone, of multiple different zones throughout a retail facility, sets of person images of a person at the first zone; capturing, by a second set of cameras each positioned at a different one of second predefined locations in the first zone, sets of product images of products within the first zone and available for purchase by customers; processing a first set of person images, of the sets of person images, and generating a unique first person identifier of the person captured within the first set of person images based on at least the first set of person images of the person at the first zone; determining there is a difference in a number of products within the first zone by comparing a first set of product images before a threshold first period of time has elapsed and a second set of product images after the threshold first period of time has elapsed; identifying a first product removed based on the determined difference in the number of products within the first zone; determining that a person is at least a threshold first distance from a portion of shelves where the first product was identified, at or after the threshold first period of time; generating a virtual first zone cart associated with the first person identifier and the first zone; and virtually adding the first product to the virtual first zone cart associated with the first person identifier.

Those skilled in the art will recognize that a wide variety of other modifications, alterations, and combinations can also be made with respect to the above described embodiments without departing from the scope of the disclosure, and that such modifications, alterations, and combinations are to be viewed as being within the ambit of the inventive concept.

1. A system for product identification and allocation within a retail facility, the system comprising:
a first set of cameras each positioned at a different one of first predefined locations corresponding to a first zone, of multiple different zones throughout a retail facility, wherein the first set of cameras is configured to capture sets of person images of a person proximate the first zone;
a second set of cameras each positioned at a different one of second predefined locations in the first zone, wherein the second set of cameras is configured to capture sets of product images of products within the first zone and available for purchase by customers;
a person identification control circuit configured to process a first set of person images, of the sets of person images, and generate a unique first person identifier of the person captured within the first set of person images based on at least the first set of person images of the person at the first zone;
a product identification control circuit configured to:
determine there is a difference in a number of products within the first zone by comparing a first set of product images before a threshold first period of time has elapsed and a second set of product images after the threshold first period of time has elapsed;
identify a first product removed based on the determined difference in the number of products within the first zone; and
determine that a person is at least a threshold first distance from a portion of shelves where the first product was identified, at or after the threshold first period of time; and
a cart generation control circuit configured to:
generate a virtual first zone cart associated with the first person identifier and the first zone; and
virtually add the first product to the virtual first zone cart associated with the first person identifier.

2. The system of claim 1, wherein the person identification control circuit and the product identification control circuit are positioned locally at the first zone within the retail facility and are communicatively coupled via a local network; and
wherein the cart generation control circuit is positioned communicatively coupled to the person identification control circuit and the product identification control circuit via a remote network.

3. The system of claim 1, wherein the person identification control circuit is configured to:
process a second set of person images capturing a second person at the first zone and generate a unique second person identifier of the second person captured within the second set of person images; and
associate the second person identifier with the first person identifier when the second person identifier is within an identifier threshold difference of the first person identifier indicating the person and the second person are estimated to be the same person.

4. The system of claim 3, wherein the person identification control circuit is configured to activate at least a first camera, of the first set of cameras, to capture a first person image of the first set of person images in response to detecting the person entering the first zone, and generate the first person identifier in response to the person entering the first zone; and
the person identification control circuit is configured to activate at least a second person camera, of the first set of cameras, to capture a second person image of the second set of person images in response to detecting the second person exiting the first zone, and generate the unique second person identifier in response to the second person exiting the first zone.

5. The system of claim 3, wherein the product identification control circuit is configured to:
determine there is a second difference in a second number of a second set of products within the first zone based on a comparison between a second image captured at a second time and a third image captured a threshold second period of time after a second person has moved a threshold second distance from the second set of products;
identify a second product, of the second set of products, removed based on the determined second difference in the second number of the second set of products within the first zone; and
wherein the cart generation control circuit is configured to virtually add the second product to the virtual first zone cart associated with the first person identifier and the first zone in response to the identification that the second product is removed and the identification that the second person identifier is within the identifier threshold difference of the first person identifier.

6. The system of claim 1, wherein the second set of cameras are spaced such that a first field of view of a first camera overlaps with a second field of view of an adjacent second camera; and
wherein the product identification control circuit, in identifying the first product having been removed, is configured to identify from a first image captured by the first camera, of the second set of cameras, that the first product is removed, identify based on a second image captured by the second camera of the second set of cameras and having an overlapping field of view with the first product, that the first product is removed; and
preventing the first product from being added twice to the virtual first zone cart based on the overlap of the first field of view of the first camera and the second field of view of the second camera.

7. The system of claim 1, wherein the first set of cameras and the second set of cameras are positioned on both a first side and a second side of an aisle within the first zone; and
wherein a first camera, of the second set of cameras, is positioned on the first side of the aisle within the first zone, and oriented with a first field of view directed to the second side of the aisle opposite the first side of the aisle; and a second camera, of the second set of cameras, positioned on the second side of the aisle and oriented with a second field of view directed to the first side of the aisle.

8. The system of claim 1, wherein the cart generation control circuit is configured to:
generate a cumulative virtual cart that is exclusively associated with the first person identifier by combining the virtual first zone cart associated with the first person identifier with one or more additional virtual zone carts each exclusively associated with a respective one of additional person identifiers each within a threshold difference of the first person identifier.

9. The system of claim 8, wherein each of the one or more additional virtual zone carts is associated with a different respective zone of the multiple different zones within the retail facility.

10. The system of claim 1, wherein the person identification control circuit in generating the first person identifier comprises generating a vector based on characteristics, within the first set of person images, of the person captured within the first set of person images.

11. A method of product identification and allocation within a retail facility, the method comprising:
capturing, by a first set of cameras each positioned at a different one of first predefined locations corresponding to a first zone, of multiple different zones throughout a retail facility, sets of person images of a person at the first zone;
capturing, by a second set of cameras each positioned at a different one of second predefined locations in the first zone, sets of product images of products within the first zone and available for purchase by customers;
processing a first set of person images, of the sets of person images, and generating a unique first person identifier of the person captured within the first set of person images based on at least the first set of person images of the person at the first zone;
determining there is a difference in a number of products within the first zone by comparing a first set of product images before a threshold first period of time has elapsed and a second set of product images after the threshold first period of time has elapsed;
identifying a first product removed based on the determined difference in the number of products within the first zone;
determining that a person is at least a threshold first distance from a portion of shelves where the first product was identified, at or after the threshold first period of time;
generating a virtual first zone cart associated with the first person identifier and the first zone; and
virtually adding the first product to the virtual first zone cart associated with the first person identifier.

12. The method of claim 11, wherein the processing the first set of person images and generating the first person identifier comprises processing, locally at the first zone by a person identification control circuit, the first set of person images and generating the first person identifier locally by the person identification control circuit;
communicating the first person identifier over a local network; and
wherein the generating the virtual first zone cart comprises accessing, via a distributed network, the first person identifier and associating the virtual first zone cart with the first person identifier.

13. The method of claim 11, further comprising:
processing a second set of person images capturing a second person at the first zone and generating a unique second person identifier of the second person captured within the second set of person images; and
associating the unique second person identifier with the first person identifier when the unique second person identifier is within an identifier threshold difference of the first person identifier indicating the person and the second person is estimated to be the same person.

14. The method of claim 13, further comprising:
activating at least a first camera, of the first set of cameras, to capture a first person image of the first set of person images in response to detecting the person entering the first zone;
generating the first person identifier in response to the person entering the first zone;
activating at least a second camera, of the first set of cameras, to capture a second person image of the second set of person images in response to detecting the second person exiting the first zone; and
generating the unique second person identifier in response to the second person exiting the first zone.

15. The method of claim 13, further comprising:
determining there is a second difference in a second number of a second set of products within the first zone based on a comparison between a second image captured at a second time and a third image captured a threshold second period of time after the second person has moved a threshold second distance from the second set of products;
identifying a second product, of the second set of products, removed based on the determined second difference in the second number of the second set of products within the first zone; and
virtually adding the second product to the virtual first zone cart associated with the first person identifier and the first zone in response to the identification that the second product is removed and the identification that the second person identifier is within the identifier threshold difference of the first person identifier.

16. The method of claim 11, wherein the second set of cameras are spaced such that a first field of view of a first camera, of the second set of cameras, overlaps with a second field of view of an adjacent second camera of the second set of cameras; and
wherein the identifying the first product has been removed comprises:
identifying, from a first image captured by the first camera having the first field of view overlapping the second field of view of the second camera, that the first product is removed;
identifying based on a second image captured by the second camera that the first product is removed; and
preventing the first product from being added twice to the virtual first zone cart based on the overlap of the first field of view of the first camera and the second field of view of the second camera.

17. The method of claim 11, wherein the capturing the sets of product images comprises:
capturing the first set of product images of a first set of products positioned on a second side of an aisle by a first camera, of the second set of cameras, positioned on a first side of the aisle within the first zone and the first camera oriented with a first field of view directed to the second side of the aisle opposite the first side of the aisle; and
capturing a third set of product images of a second set of products positioned on the first side of the aisle by a second camera, of the second set of cameras, positioned on the second side of the aisle and oriented with a second field of view directed to the first side of the aisle.

18. The method of claim 11, further comprising:
generating a cumulative virtual cart that is exclusively associated with the first person identifier by combining the virtual first zone cart associated with the first person identifier with one or more additional virtual zone carts each exclusively associated with a respective one of additional person identifiers each within a threshold difference of the first person identifier.

19. The method of claim 18, further comprising:
associating each of the one or more additional virtual zone carts with a different respective zone of the multiple different zones within the retail facility.

20. The method of claim 11, wherein the generating the first person identifier comprises generating a vector based on characteristics, within the first set of person images, of the person captured within the first set of person images.
